(19) United States
(12) Patent Application Publication
(10) Pub. No.: US 2010/0198651 A1
(43) Pub. Date: Aug. 5, 2010

(54) Integrated infrastructure operations management system and method

(76) Inventors: Stephen Michael Johnson, Allen, TX (US); Alexandra Passos Ronngren, Conroe, TX (US)

Correspondence Address: KEVIN MARK KLUGHART, 2516 LILLIAN MILLER PARKWAY, SUITE 115, DENTON, TX, 76210-7205, US

(21) Appl. No.: 12/657,920

(22) Filed: Jan. 30, 2010

Related U.S. Application Data
(60) Provisional application No. 61/206,365, filed on Jan. 31, 2009.

(51) Int. Cl. G06Q 10/00

(52) U.S. Cl. 705/9; 705/301; 705/8

(57) ABSTRACT

A business computing system and method for integrated management of operations and infrastructure of a business is disclosed. The system architecture contains data stored in one or more relational databases, web-based, and/or non-web based user interfaces provided by an aggregation of software, automated processes, and a transaction processing system. A standardized interface is defined for modular components to be incorporated. A specialized business process description and control language is utilized to support flexibility, configuration, and modeling of processes. Persistent messaging is utilized for inter-process communication. Various other processes and components provide automation and integration with external systems/subsystems. The purpose of this combination of applications and business processes is to provide a robust and flexible enterprise management platform for managing infrastructure (including facilities, cabling, security, furniture, etc.) and information technology (IT) services (including network, voice, platform management, printing, etc.).

### CROSS REFERENCE TO RELATED APPLICATIONS

### Provisional Patent Applications

Applicants claim benefit pursuant to 35 U.S.C. §119 and hereby incorporate by reference Provisional patent application for “INTEGRATED INFRASTRUCTURE OPERATIONS MANAGEMENT SYSTEM AND METHOD”, Ser. No. 61/206,365, filed Jan. 31, 2009 and mailed to the USPTO on Jan. 31, 2009 with Express Mail Label EH474064429US.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention is related to the field of enterprise software systems/applications for managing the infrastructure operations of enterprise organizations. These systems/applications generally coordinate and control widespread and often diverse components of a business/enterprise operation, and aid facilities and services personnel in the proper maintenance and daily operation of a physical plant or diverse business enterprise.

Infrastructure operations refers to the management and control of the facility, the Information Technology (IT) services provided/housed within the facility, and related business units and processes. The facility includes, but is not limited to, the buildings, floor plan, cable plant, security, and climate control. IT services includes, but is not limited to, networking, telecommunications, computing hardware (server and desktop), and printing support/management. Management and control refers to enabling, provisioning, planning, fulfilling, and measuring the facility, services, and related processes and activities.

### DESCRIPTION OF THE PRIOR ART

The field of prior art associated with infrastructure operations management generally does not address the use of software or other business applications to fully integrate infrastructure operations management for a given business enterprise. While some components of the current invention may exist on a standalone basis (point solutions), the field of prior art has (as yet) been unable to properly integrate all infrastructure operations management for traditional business enterprises.

### DEFICIENCIES IN THE PRIOR ART (0100, 0200)

The prior art as it relates to infrastructure management solutions is generally illustrated in FIG. 1 (0100) (including other enterprise computing systems such as Enterprise Resource Planning (ERP), Business Process Modeling (BPM), Business Intelligence/Enterprise Performance Management (BI/EPM), Operations/Business Support Systems (O/BSS), and Integrated Workplace Management Systems (IWMS)) generally suffers from a variety of functional deficiencies, that may be included in one or more of the following categories:
LIMITED SCOPE. Current enterprise applications (0111, 0112, 0113, 0114, 0115, 0116) limit their scope/focus to a specific business function, unit, or organization (0101, 0102, 0103). Many new business units have been created and/or expanded to support the advent of newer technologies, especially those related to computing systems. A plurality of these business units exist within most enterprise organizations, and each of these business units has developed or purchased applications to support only their immediate (short-term) and/or limited needs. Many times there are gaps between these applications in functionality, interoperability, scalability, usability and/or accounting. Over time, the weaknesses of these applications are exposed and they become out-dated or otherwise obsolete. Therefore, enterprise organizations develop and/or purchase other applications, that are again focused on a small subset of the overall business needs. This cycle repeats and businesses end up with a large number of point solutions, each with a limited scope/focus. While this approach does have some merit in other business areas, this limited scope/focus inhibits full control and management of infrastructure operations, and causes businesses to incur greater costs with fewer benefits.
SINGLE-USER FOCUS. Many current enterprise applications (0111, 0112, 0113, 0114, 0115, 0116) focus only on the needs of single users/groups (0105, 0105, 0106, 0107, 0108, 0109, 0110) or their managers/executives (0120, 0121, 0122, 0123). If the focus of the tool is for management/executives, then the application typically requires manual effort to populate the data from other applications and databases (0118, 0119), or the business must spend resources (time and/or money) to develop other applications to integrate their plethora of enterprise applications. Because of the aforementioned gaps in the data, oftentimes the validity of the data provided by management-focused applications is inaccurate, invalid, and/or lacking integrity. Thus it has limited benefit for accountability anyway. Also, these management-focused applications almost never provide benefit to, or even interfaces for, other internal and/or external users/groups.
LIMITED APPLICATION ACCESS. In conventional prior art approaches, generally as illustrated in FIG. 1 (0100) a few applications (0111, 0112) are designed for internal users, such as the technicians (0203), administrators (0204), and facilitators (0205) illustrated in FIG. 2 (0200), may provide some interface or usability for managers, but they rarely provide any method for external users/customers (0210) to request service or report problems. Most enterprise organizations have a plurality of customized and home-grown enterprise applications called support tools (0209, 0217) designed for internal users to support certain products and processes. As with most other enterprise applications, these do not interconnect, and usually do not provide any method or mechanism to share information outside of their organization. Enterprise applications (0209) focused on providing external and internal users are usually home-grown, and rarely have any connection to the business data/intelligence (0213, 0214, 0215, 0216). Thus, these applications only support direct input of information, without any means to validate or control the data entered. Collectively, these applications fail to address the overall business needs, and typically only provide little, if any, return on investment.
LACK OF INTEGRATION. As mentioned above, current enterprise applications lack integration between organizations (0101, 0102, 0103) and often even between applications (0111, 0112, 0113, 0114, 0115, 116) within the same organization. Externally, these relationships do not exist, because the other applications and data sources (0117, 0118) are not included within their executives/managers (0120, 0121, 0122, 0123) scope of control. Even to achieve some level of integration with applications inside their organizations, managers/executives must expend resources (time and/or money) to develop software to facilitate the communication or manually export, translate and load the data. To get complete integrations this added cost is multiplied by the number of enterprise applications utilized by the enterprise organization.
DOMAIN IDENTIFICATION. Many enterprise organizations (0101, 0102, 0103) have opted to centralize enterprise applications (0111, 0112, 0113, 0114, 0115, 0116). However, these applications do not provide any method to structure data to support the added complexity of supporting multiple geographically disparate campuses/sites. In fact, enterprise applications should include mechanisms and/or methods to facilitate data autonomy, segregation, and integrity. Lacking this feature/ability forces the business units (data owners), that are responsible for the application, to develop strategies to circumvent these short-comings. Often, this involves mangling the data, and/or otherwise “denormalizing” the data.
PRIMARY VS. ANCILLARY DATA. Current enterprise applications (0111, 0112, 0113, 0114, 0115, 0116) use data models that are either fixed or non-referential, resulting in a lack of integrity or flexibility to support a variety of business requirements. To allow for both integrity and flexibility, it is necessary to store certain key elements (primary) data in one table. While a secondary (ancillary) table is needed that allows an unlimited volume of data for indefinite purposes, uses, and/or reasons. The ancillary data should include elements to describe the type of data that may also provide module developers a method of searching and utilizing the ancillary data.
NON-MODULAR. Current enterprise applications (0111, 0112, 0113, 0114, 0115, 0116) tend to be non-modular, and therefore, they are more difficult to modify or upgrade. Because the scope of the applications tends to be narrow, the designers of the applications rarely understand the need for the application to be modular. However, those applications that do support multiple business units, force the enterprise to utilize the application for all of the relevant business units. This all or nothing approach usually does not address the specific needs of each level/type of user, and typically is costly (time and money) and cumbersome to operate and maintain.
INFLEXIBLE. Current enterprise applications (0111, 0112, 0113, 0114, 0115, 0116) tend to be inflexible because of their underlying design. As stated previously, usually these applications are designed to only serve a limited purpose. Thus they are not expected to adapt to even minor changes in business needs and/or processes. This lack of flexibility forces businesses to repeatedly purchase new applications as technology and/or business needs change.
LACK OF METRICS AND MEASUREMENTS. Current enterprise applications (0111, 0112, 0113, 0114, 0115, 0116) tend to lack management controls and accounting for performance management. While these applications may provide functionality for internal (0203, 0204, 0205) and/or external users (0210), the applications do not provide methods or processes for measuring the use and/or productivity of these systems.
REQUIREMENTS FOR ADDITIONAL/EXCESSIVE CUSTOMIZATION AND MAINTENANCE. As described above, current enterprise applications (0111, 0112, 0113, 0114, 0115, 0116) usually require significant customization, modification, and/or other development to be ready for deployment, thus significantly increasing their cost of ownership.

While one skilled in the art will recognize that this list is not exhaustive, it does illustrate the lack of needed functionality in the prior art.

### GENERAL APPROACH OF THE INVENTION

Without limiting the scope of the present invention, the general approach taken by the present invention is a combination of software and business processes for fully supporting infrastructure operations management. The system architecture (0600, 1100) contains data stored in one or more relational databases (0611, 0923, 1101, 1407, 1505, 3105, and detailed in FIG. 17 (1700)-FIG. 30 (3000)), a plurality of web-based and/or non-web based user interfaces (0600), optimized for a plurality of users (0602, 0603, 0604, 0605, 0606), provided by an aggregation of software applications (0601), specialized tools and processes (0609), and a transaction processing system (0506, 0608, 0800, 0900, 1000). A standardized application architecture (1100, 1200, 1300, 1400, 1500, 1600) is defined for modular components (1113, 1300, 1400, 1504, 1607, 3104) to be incorporated. A business process description and control language may be utilized to support flexibility, configuration, and/or modeling of processes. Persistent messaging may be utilized for inter-process communication.

Various other processes and components may provide automation and integration (0610, 1110) with external computing systems.

The purpose of this combination of software and business processes is to provide a robust and flexible enterprise management platform for managing infrastructure operations, as a whole.

### OBJECTIVES OF THE INVENTION

The approach embodied in the present invention differs from other enterprise computing systems such as Enterprise Resource Planning (ERP), Business Process Modeling (BPM), Business Intelligence/Enterprise Performance Management (BI/EPM), Operational/Business Support Systems (O/BSS), and Integrated Workspace Management Systems (IWMS) in a variety of ways. Accordingly, the objectives of the present invention are (among others) to circumvent the deficiencies in the prior art and affect the following objectives:
PROVIDE AN INTEGRATED INFRASTRUCTURE OPERATIONS MANAGEMENT SOFTWARE SYSTEM. Unlike ERP, BPM and BI/EPM the present invention focuses on integrating infrastructure operations of a business as a whole as generally illustrated in FIG. 3 (0300) and FIG. 4 (0400). The present invention provides a comprehensive combination of processes, applications, and interfaces for a plurality of users. To facilitate this goal, the present invention utilizes a relational database management system (RDBMS—0611, 0923, 1101, 1407, 1505, 3105, and detailed in FIG. 17 (1700)-FIG. 30 (3000)) as a unified Operational Data Storage (ODS) for the business and system data. Several other enterprise applications take a partial or limited approach, with the afore-mentioned short-falls. However, the present invention focuses on including all of infrastructure operations in one RDBMS. The benefit this provides is unification of business processes, increased communication, increased data integrity, reduced duplication, and overall more accurate and granular cost controls. Additionally, the present invention ensures proper data ownership and accountability. Unification of these processes and subsequent data prevents business units from becoming disjointed by providing effortless integration. Unification provides increased integrity and less effort to maintain because processes that alter/change the data are owned/managed by the organization responsible for managing the related facility/service. Additionally, integrated processes are managed as a cohesive unit, which ensures communication among stakeholders.
SEPARATION FROM OTHER BUSINESS PROCESSES/SYSTEMS. The present invention, however, does not include elements or processes outside of infrastructure operations. While operations may need some subsets of data from corporate-level organizations such as supply, finance, and human resources (0302, 0303, 0304), these organizations often do not share the same process interdependencies. This lack of co-dependency allows applications at the enterprise level to be created that specialize in the needs of the organizations at that level, because the perspectives and requirements differ within the other business areas. Therefore, integration components/processes (0610, 1110) are needed to facilitate populating data from one computing system to another. The lack of data co-dependency makes it not only advantageous to separate to reduce complexity, but, in many cases, it is necessary to separate the processes and data in order to limit data exposure and contention.
DEFINE DOMAINS. As mentioned before, the prior art does not utilize the domain concept to structure the data. This concept facilitates data autonomy, segregation, and integrity. Data within the RDBMS must be encompassed in a domain (1701, 1801, 2001, 3004) by providing a unique identifier for the given domain in all primary and ancillary data in the active and historical classifications and all transactional data. This domain element can then be used for archival purposes, and/or centralizing/co-locating operations from multiple locations on a single implementation of the present invention.
MANAGE PRIMARY AND ANCILLARY DATA. Data models within the prior art are either fixed or non-referential. Fixed enterprise applications lack flexibility to support the myriad of business requirements to be practical for all implementations, while non-referential enterprise applications lack integrity to be sustainable and reliable. By separating the data into primary and ancillary data, the core data is structured to ensure referential integrity while other ancillary (AKA non-core) data is structured to support an infinite variety of elements.
PROVIDE MULTIPLE USER-SPECIFIC INTERFACES. The present invention takes a truly unique approach from most enterprise applications in that it provides specialized/optimized interfaces for all users and processes within infrastructure operations. Instead of utilizing tactical solutions that facilitate the needs of either one business unit/discipline (vertically) or one user segment (horizontal), this solution provides a multi-faceted approach. These interfaces provide the appropriate tooling for end-users and management as well as discipline specific tooling for technicians, administrators, and support organizations.
MODULAR DESIGN. Because many businesses will only need and/or want to adopt certain aspects of the present invention at one time, the present invention is designed to be modular. This may allow businesses to utilize as many/few of the modules/components (1113, 1300, 1400) as they choose. Thus, the present invention may be deployed in an infinite array of configurations. Additionally, the modular design provides the ability to add and remove additional modules/components, as needed, without transitioning to another application or platform. These new modules can include any combination of new features, enhancements, bug-fixes, and support new technologies. Similarly, modules can be removed when the feature is no longer needed or supported.
FLEXIBLE DESIGN. In addition to the modularity, the present invention also leverages a business process description and control language to provide an unprecedented level of flexibility. Using this language, the present invention may be configured to handle the unique requirements of any enterprise organization. This language may similarly be utilized to help businesses structure, document, and display their business processes in a manner similar to traditional business process modeling (workflow analysis) without the need for special tooling or for additional effort.
MANAGERIAL ACCOUNTING. Because of the unique nature of the present invention, an unprecedented level of analytics and metrics can be extracted from the supported operations. This feature may provide managers and executives with needed information for planning and performance measurement/monitoring.
SIMPLE TO DEPLOY AND SUPPORT. Unlike many of the alternative solutions presented in the prior art, the present invention does not require additional development or support except to activate the application by populating the data in the database. This provides a near turn-key solution to infrastructure operations management, and minimal long-term costs compared to alternative approaches.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION (0300, 0400, 0500, 0600, 0800, 0900, 1000)

### Overview

As generally illustrated in FIG. 1 (0100), all prior-art enterprise computing solutions designed for managing portions of the infrastructure operations of a business are generally dysfunctional in most centralized office (campus) environments. The orthodox approach to supporting these business units can be traditionally grouped as one of the following:

1. Enterprise Resource Planning (ERP);

2. Business Process Modeling (BPM);

3. Business Intelligence/Enterprise Performance Management (BI/EPM);

4. Operational/Business Support Systems (OSS/BSS); or

5. Integrated Workplace Management Systems (IWMS).

Each of these general categories of approaches may provide a modest amount of benefit to a business, but the lack of integration significantly limits the efficiency and efficacy of such systems.

The present invention as generally illustrated in FIG. 3 (0300) succeeds in integrating various groups within a given corporate enterprise (0301) by introducing shared databases between various enterprise group intersections (0321, 0322, 0323, 0324). These intersected databases are then controlled by the interaction of three processes: resource management (0313), problem management (0314), and request management (0315) that permit integrated control, management, dissemination of corporate resources in response to overall enterprise needs and goals.

This concept is more generally described in FIG. 4 (0400), wherein the full potential benefit of the present invention is realized when IT services (0402) and facilities management (0404) organizations share a common database (0611, 0923, 1101, 1407, 1505, 3105, and detailed in FIG. 17 (1700)-FIG. 30 (3000)) and an interconnected software system (0601). The database should contain business data including active (1104, 1702, and detailed in 1800, 1900 and 2100-2900), historical (1105, 1703, 2000), and transaction/activity (1106, 1704, 3000) data linked by a common domain (1701, 1801, 2001, 3004).

The software system as taught by the present invention provides a common transaction processing system (0506, 0608, 0800-1000) that includes problem, request and change management, as well as a plurality of methods, applications, interfaces, services, and features needed by business organizations to manage infrastructure operations.

The underlying shortfall of conventional enterprise software applications designed for infrastructure operations is that the business needs differ from the focus of these conventional solutions. In most modern businesses with a large consolidated/centralized infrastructure (e.g., campuses, medical facilities, and government agencies) the operations of the business are located in a limited number of buildings within a relatively small geography. Although solutions exist to tactically approach and resolve the needs of the business, these solutions do not address the real needs presented in this consolidated business environment. This is further perpetuated by the fact that businesses continue to grow their IT infrastructure, which then forces them to purchase additional specialized solutions and retain appropriate specialists to manage these enterprise applications. These tactical solutions/mechanisms must also be integrated using a motley assortment of internally developed and third party tools. All of which must be integrated and maintained perpetually.

Institutions that have not invested in the orthodox solutions have instead opted to utilize home-grown/in-house solutions (0209). In addition to being less feature-rich, these solutions present another level of risk due to their inherent lack of redundancy, security, and/or adaptability. At best, these solutions provide a rapid, low-cost solution to an immediate need, but the solution risks increase over time and have caused companies significant problems when the solutions fail.

### GENERAL CONCEPT

As generally illustrated in FIG. 4 (0400), the real business needs can only begin to be understood after one realizes that infrastructure operations includes the people (0403), facility (0404), and IT services (0402). At this level, these business units are highly dependent/interdependent, and share the same infrastructure and customer base. By approaching the business needs from this comprehensive view-point, operations as a whole (0400), one can begin to see a path to a more beneficial and complete solution. By approaching infrastructure operations as a whole (unifying operations), the next major problem that can be resolved is that service providers will have accurate data about the infrastructure in that they provide their service.

In fact, by having a unified database, or operational data store, this can be taken even further by providing all related organizations with relevant data from other operations departments. This permits integration of request/problem/resource management (0401) for the first time in the corporate enterprise environment. Because individual business units will not need to develop processes to manage data outside of their scope of influence/control, this may yield a significant increase in data reliability and a reduction in effort. By realizing that business operations are already co-dependent and inter-related (0400) and unifying the operations business solutions, businesses may become more efficient.

By understanding the shortcomings of prior enterprise software, and addressing the complete business needs around infrastructure operations management, the present invention provides significant reduction in the cost of operations by improving/enabling efficient management of operations units and resources, and maximizing business potential. The present invention maximizes business potential by helping businesses streamline and automate their business processes, reduce the complexity and confusion inherent in business organizations, improve collaboration and communications between business units/organizations (0101, 0102, 0103), and empowering external/end users/customers (0210, 0501, 0606) to perform common technical tasks without posing any additional risk or technical training. All of this is delivered in a way that also provides added control and unprecedented visibility (granularity) to operations activities.

Additionally, recovering resources is another method of ensuring efficient management. A resource, in this sense, includes any physical or virtual entity, of finite quantity, that can be allocated to an individual or group. This includes but is not limited to network addresses, virtual network segments, physical hardware, software licenses, phone numbers, furniture, and office space. By having visibility to the changes that may affect the use of these resources, business units can more effectively manage cost and resource recovery. Most physical assets are also resources because in addition to managing the intangible resources this solution provides traditional asset and resource allocation management without additional effort.

### BRIEF DESCRIPTION OF THE DRAWINGS

For a fuller understanding of the advantages provided by the present invention, reference should be made to the following detailed description together with the accompanying drawings wherein:

FIG. 1 illustrates the prior art, and how other enterprise applications are typically deployed and connected/related;

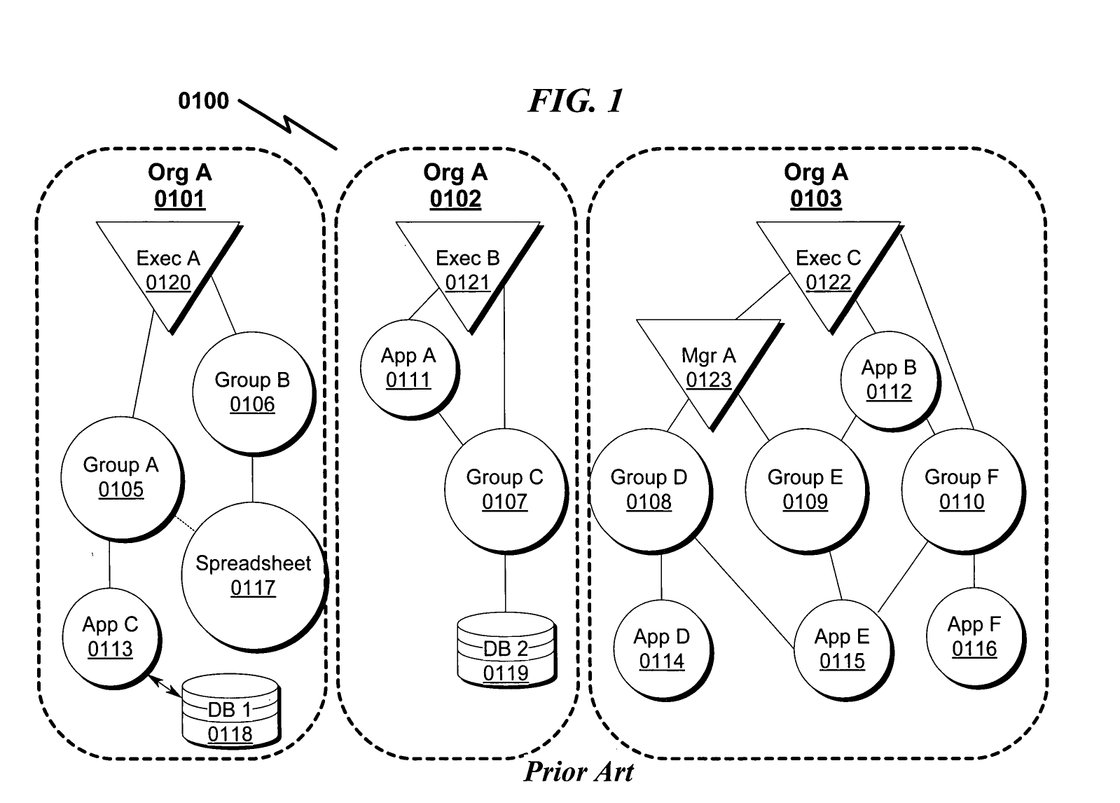

FIG. 2 Further illustrates the prior art, and contention/confusion the customer faces when using traditional enterprise applications;

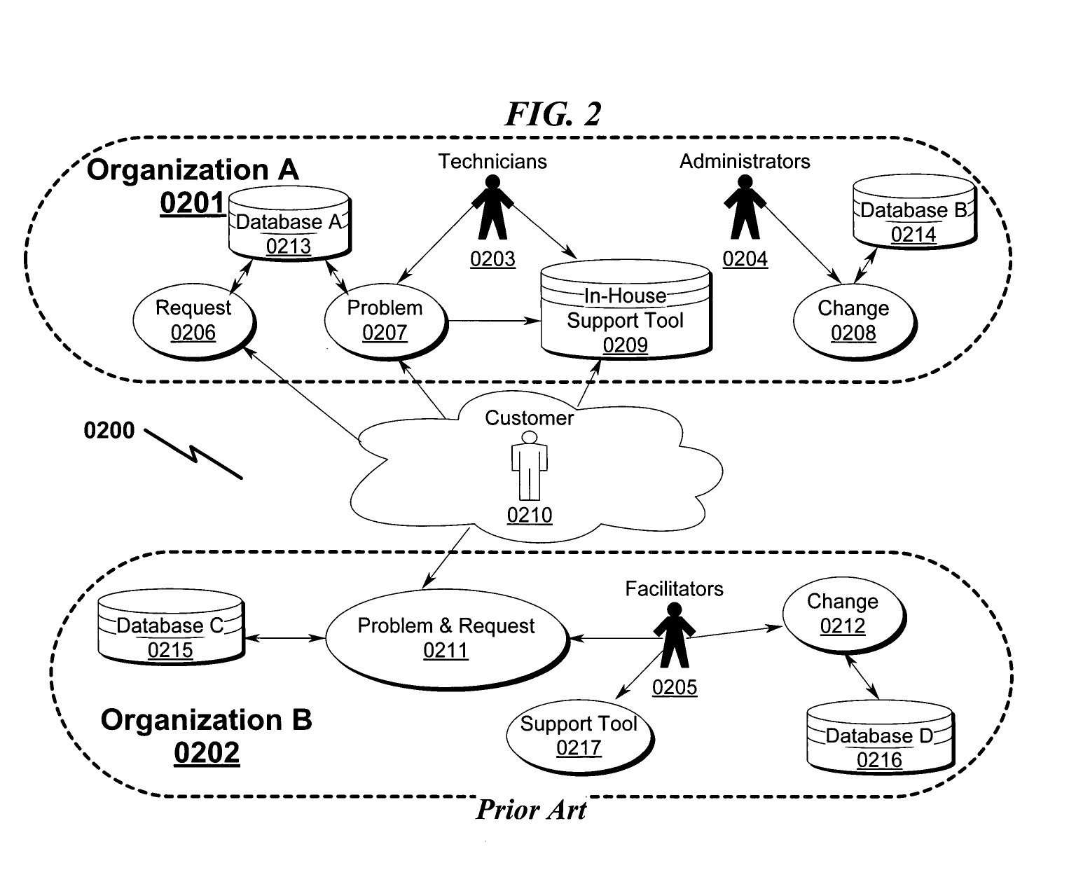

FIG. 3 illustrates the normal structure and grouping of infrastructure operations and the relationship with other organizations within the enterprise;

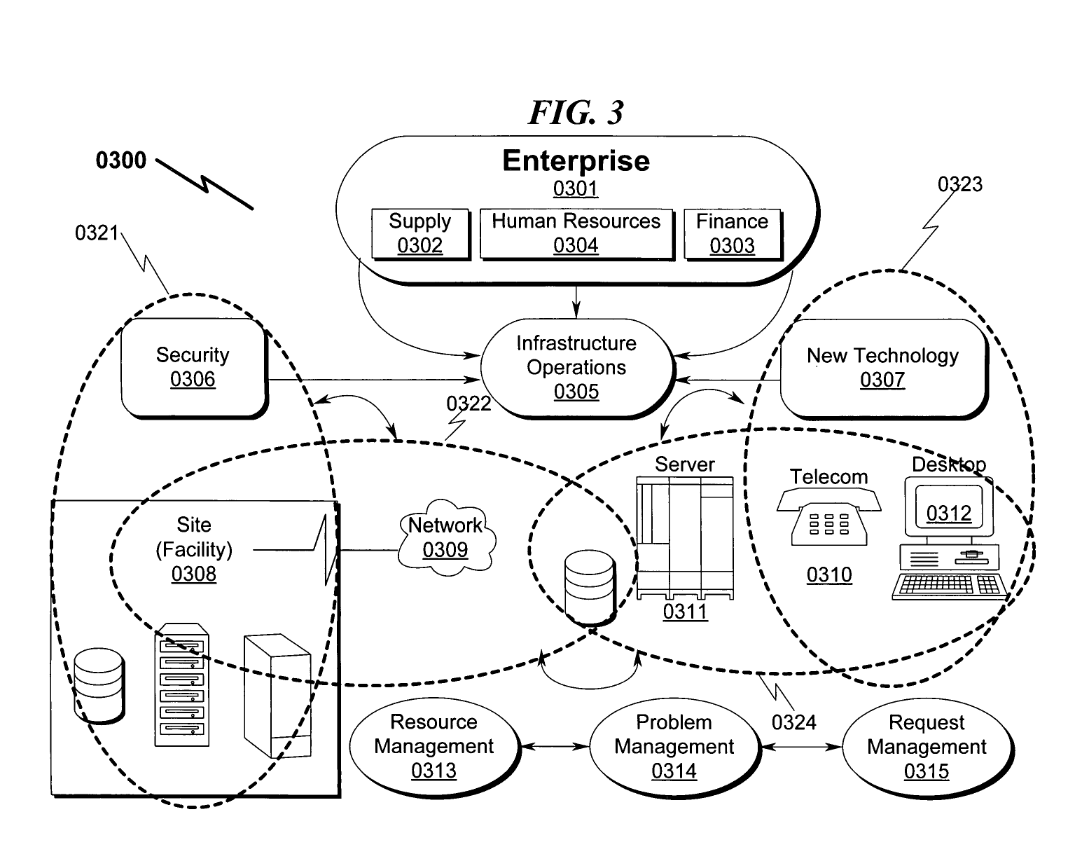

FIG. 4 illustrates the relationship between business areas and interconnected processes in infrastructure operations;

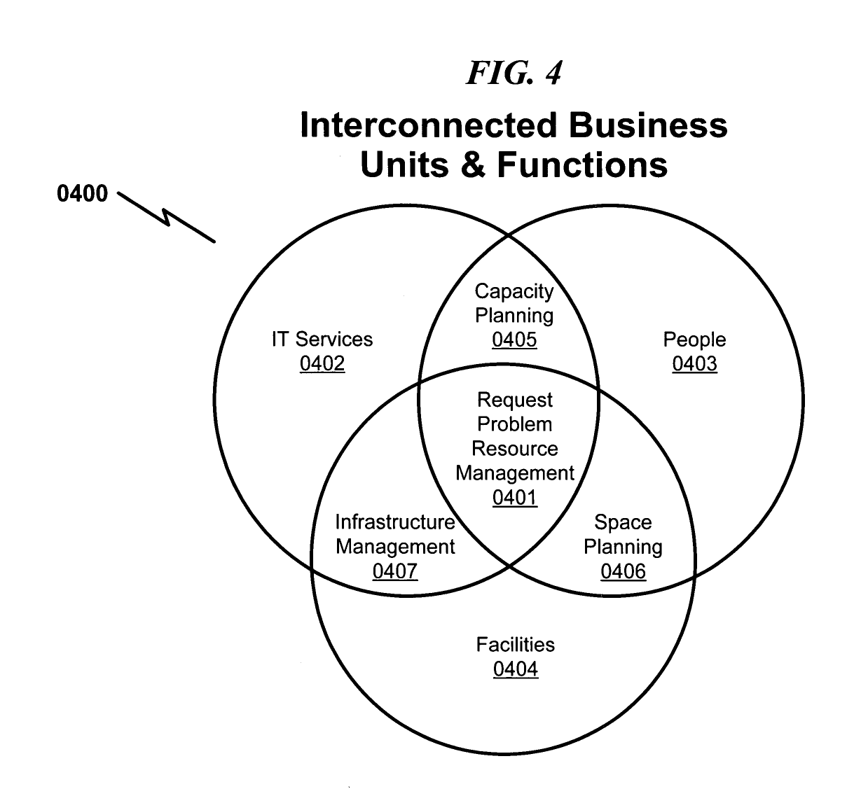

FIG. 5 illustrates an exemplary embodiment of the transaction processing system incorporated into the present invention, its primary components/functions, and the general classifications of users;

FIG. 6 illustrates the users, applications, and interfaces incorporated in the present invention;

FIG. 7 illustrates the proper structure of an enterprise application focused on infrastructure operations management as applied to the present invention;

FIG. 8 illustrates the common components and users of an exemplary embodiment of a transaction processing system incorporated into the present invention;

FIG. 9 illustrates the common stages and processes in a typical transaction processing system;

FIG. 10 illustrates the common process flows of a preferred embodiment of a transaction processing system as applied to the present invention;

FIG. 11 illustrates the major components of the application architecture utilized within the present invention;

FIG. 12 illustrates the Services and Engines utilized as core components within some preferred embodiments of the present invention as implemented on an application server;

FIG. 13 illustrates the Modules and Add-ons, additional components that provide special functionality and features needed by some embodiments of the present invention;

FIG. 14 illustrates the General Module Design, common (sometimes required) sub-components of some preferred embodiments of the present invention;

FIG. 15 illustrates the interfaces and relationship of components and users via the transaction processing system (TPS) as applied to some embodiments of the present invention;

FIG. 16 illustrates the interfaces and relationships of components and users directly with the organizational and non-organizational specific modules (i.e., without the transaction processing system) in some embodiments of the present invention;

FIG. 17 illustrates the overall database design utilized in some embodiments of the invention and shows the connection of the Business (1714) and System (1715) data;

FIG. 18 illustrates the active data group design utilized in some embodiments of the present invention. This is the basic structure of the data elements in the active portion of the business database;

FIG. 19 illustrates the connection of the groups of data in the active portion of the business database;

FIG. 20 illustrates the connection of the groups of data in the historical portion of the business database;

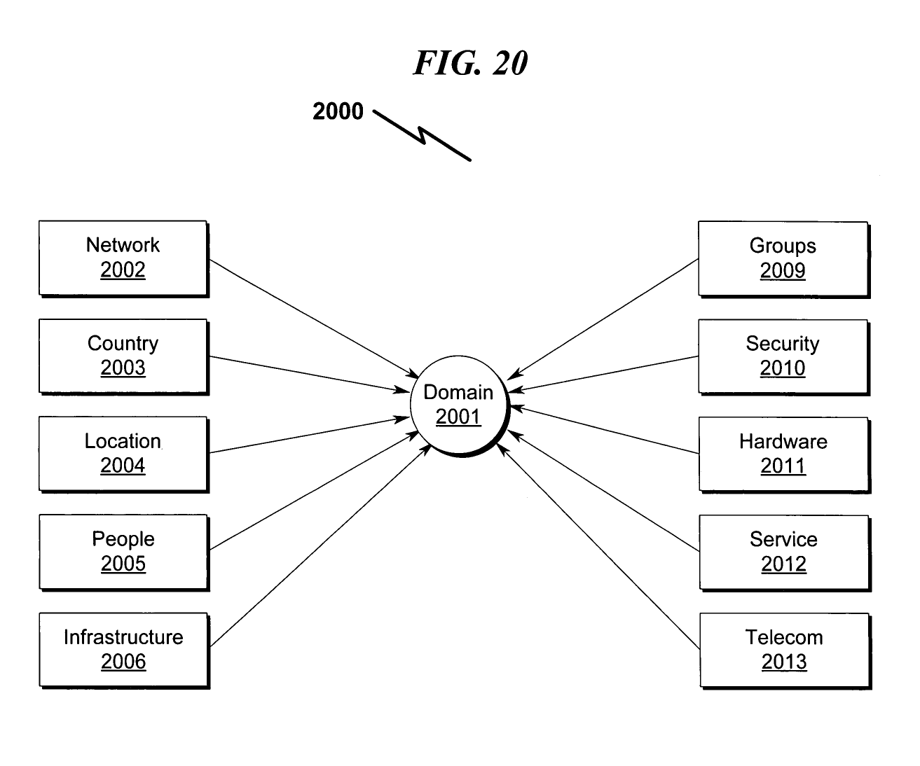

FIG. 21 illustrates the components and connections of the company and location data;

FIG. 22 illustrates the components and connections of the infrastructure data;

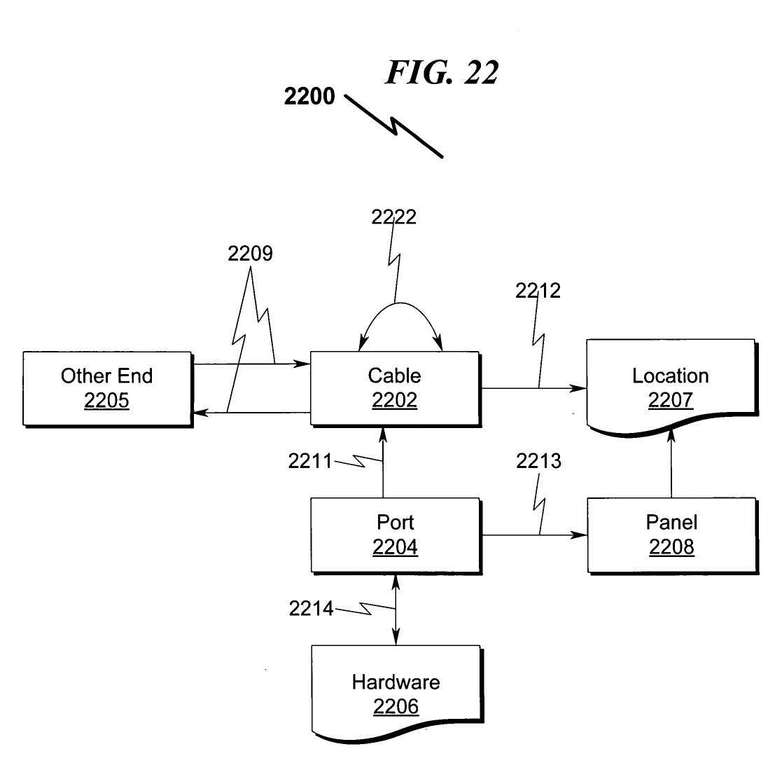

FIG. 23 illustrates components and connections of the group and people data;

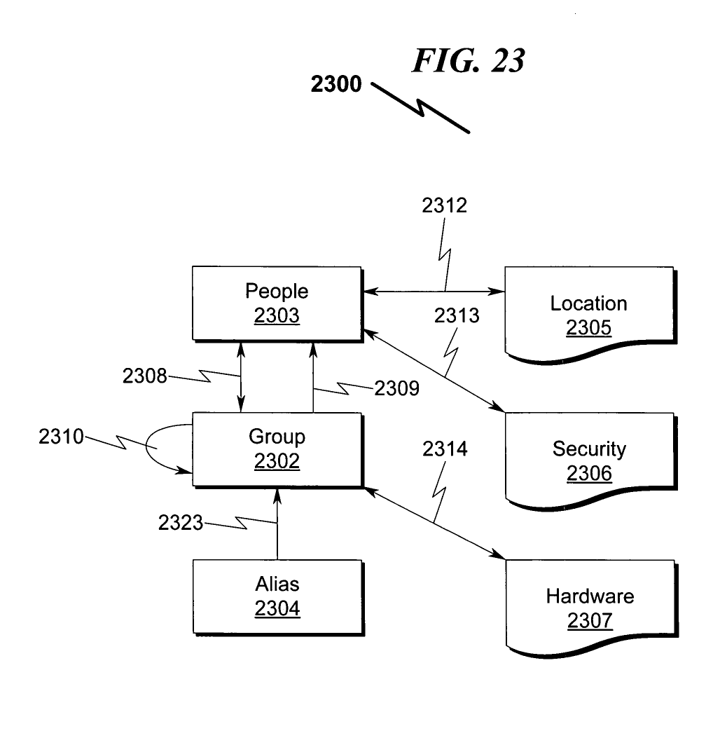

FIG. 24 illustrates the components and connections of the security data;

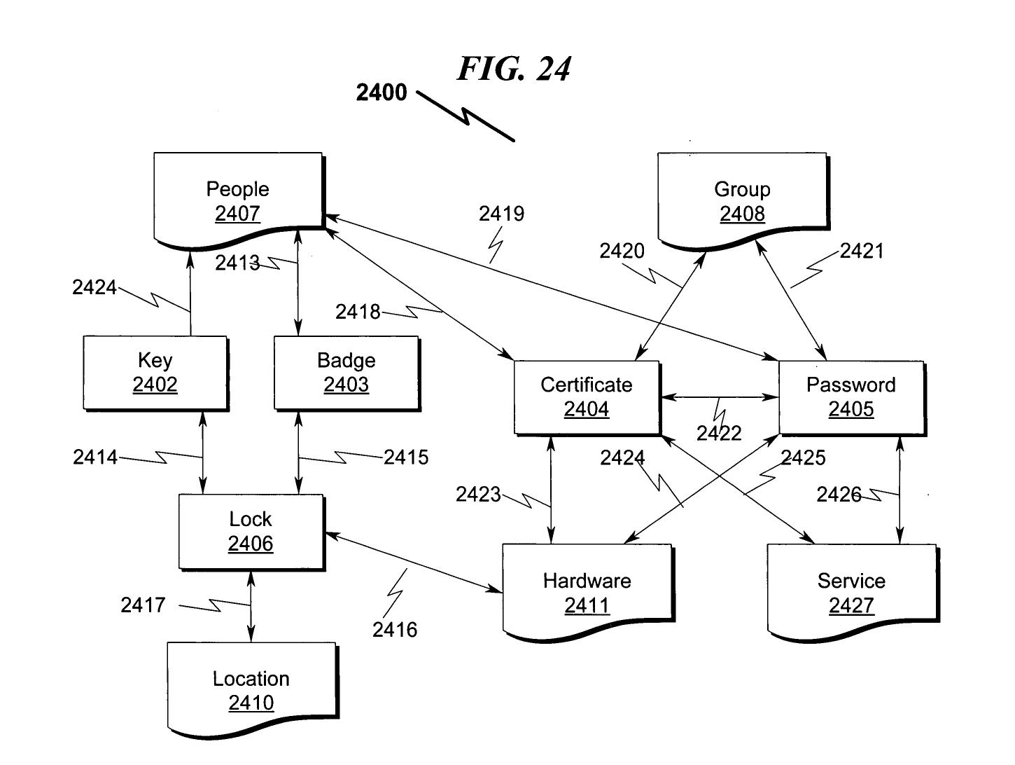

FIG. 25 illustrates the components and connections of the network data;

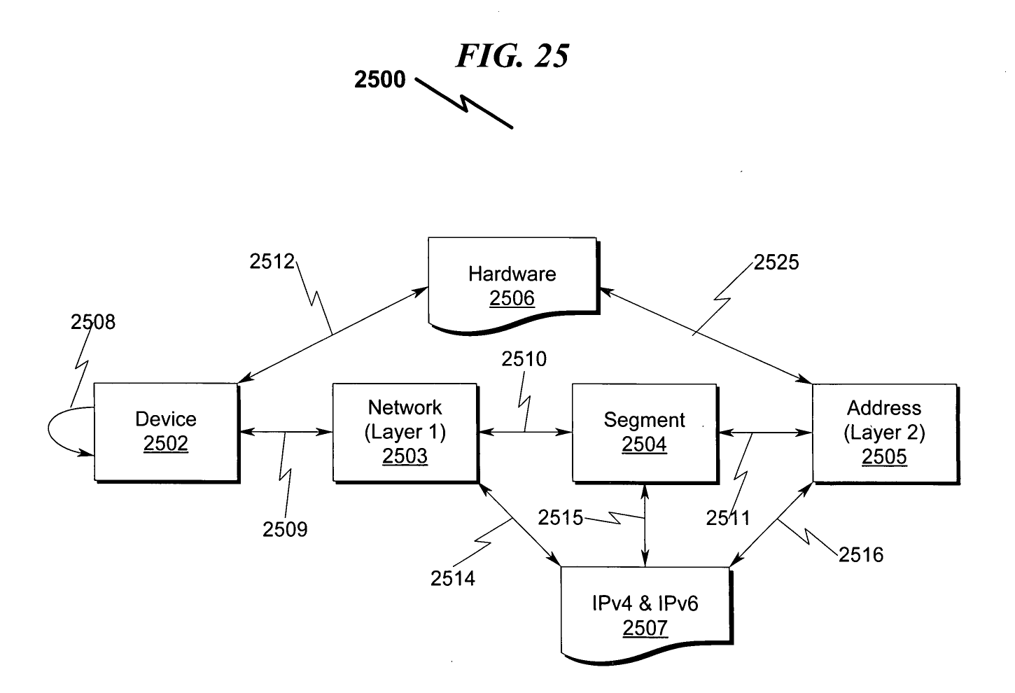

FIG. 26 illustrates the components and connections of the OSI layer-3 data, one potential method of addressing possible data communication within some embodiments of the present invention.

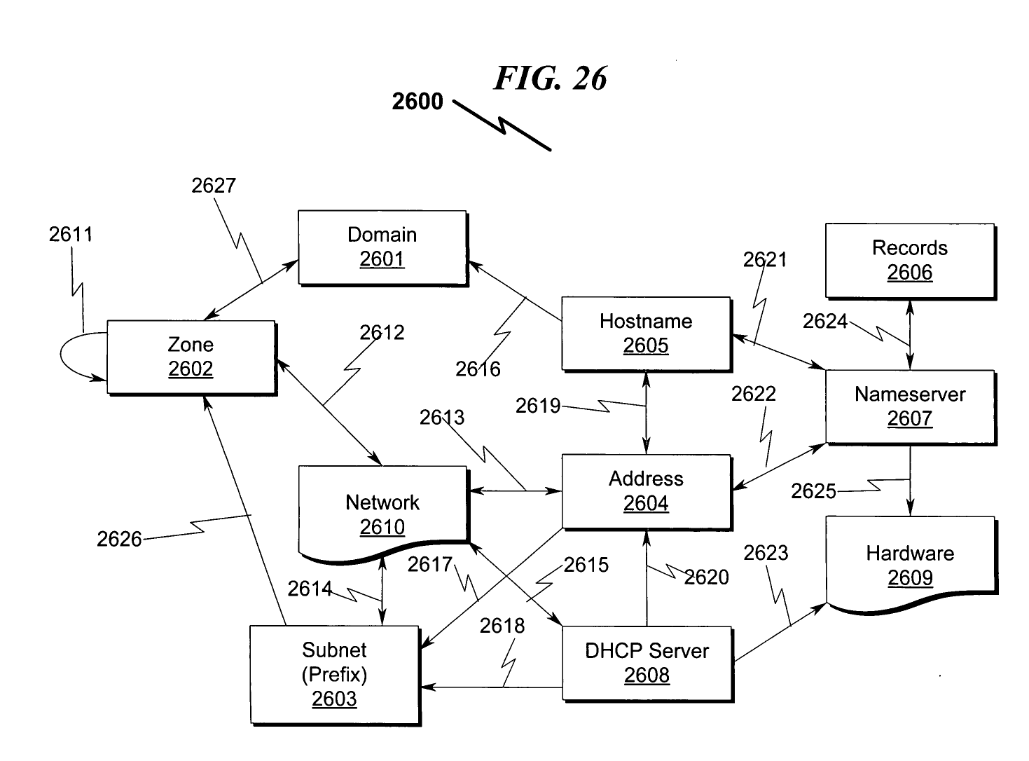

FIG. 27 illustrates the components and connections of the service data;

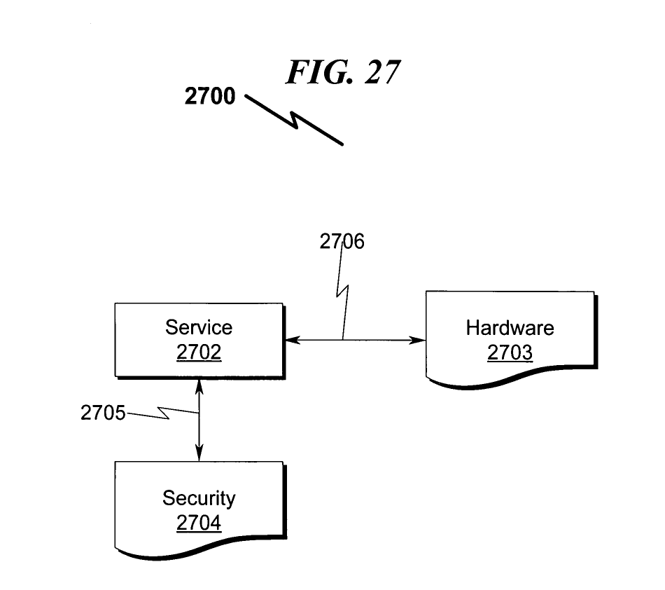

FIG. 28 illustrates the components and connections of the telecom data;

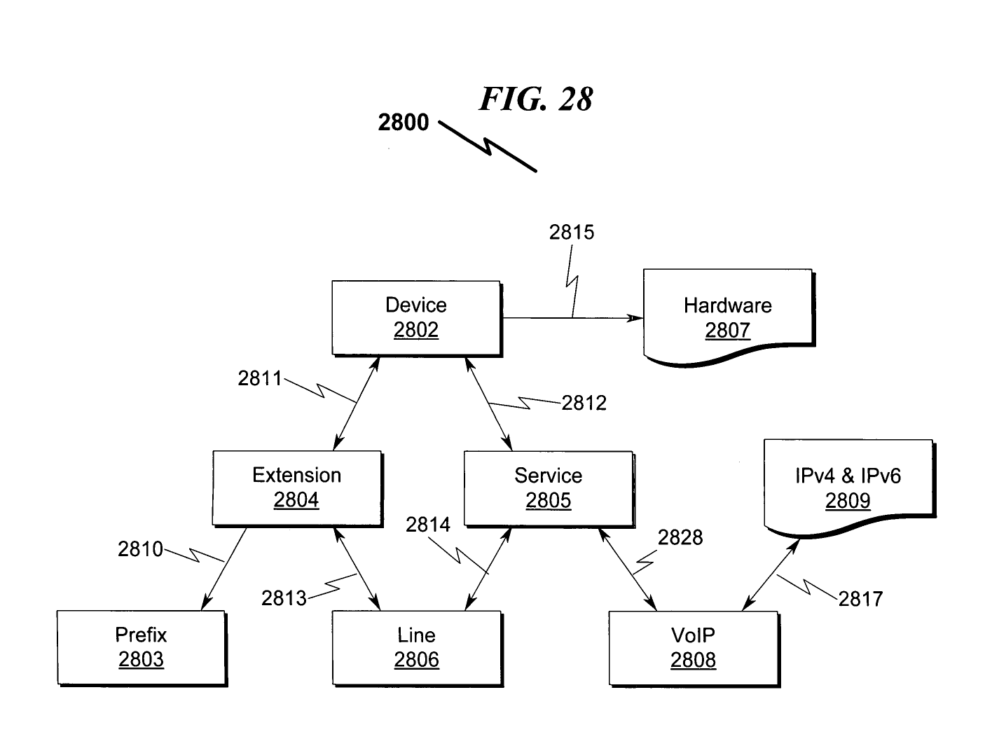

FIG. 29 illustrates the components and connections of the hardware data;

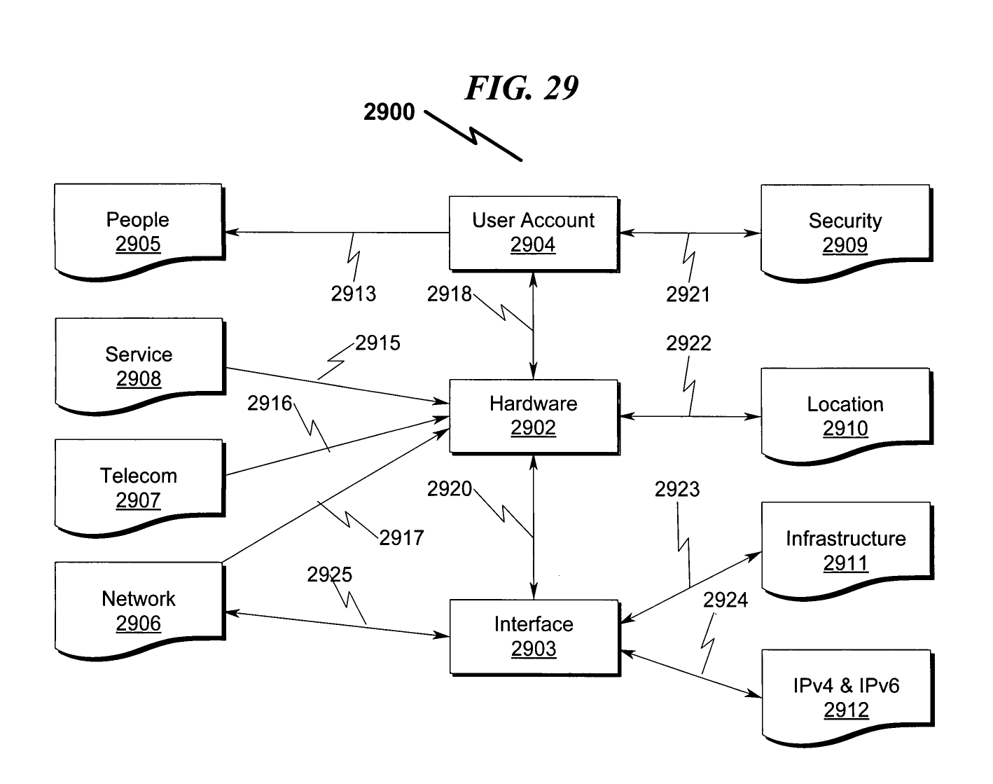

FIG. 30 illustrates the relationships of the action data;

FIG. 31 illustrates the process flow of actions through modules and queues;

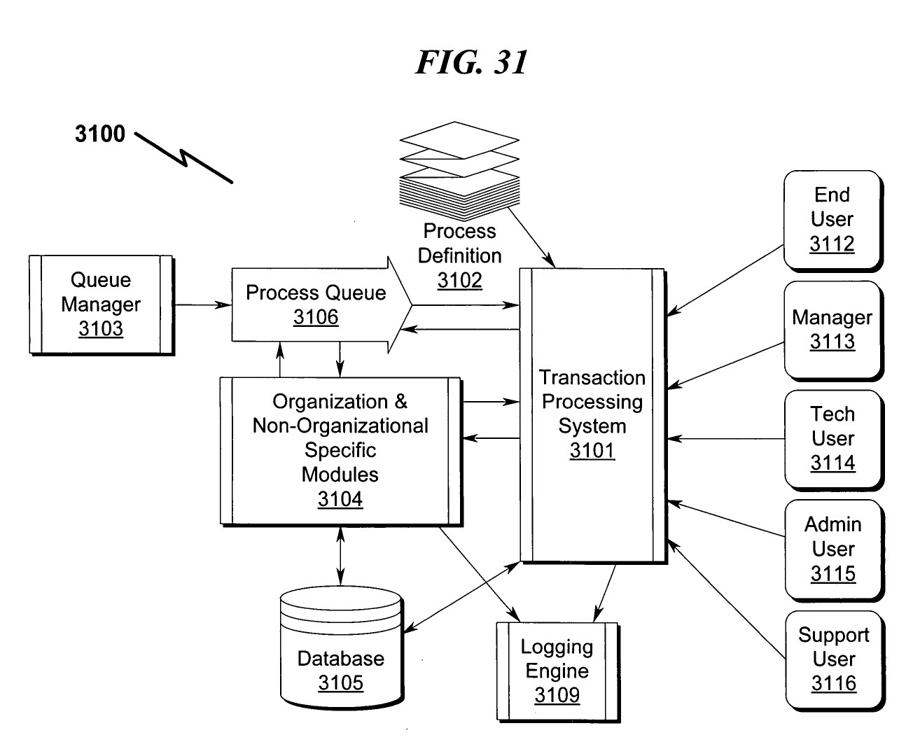

FIG. 32 illustrates an exemplary embodiment of the present invention system;

FIG. 33 illustrates an exemplary embodiment of a transaction processing method useful in many preferred embodiments of the present invention;

FIG. 34 illustrates an abstraction model of the present system invention;

FIG. 35 illustrates an abstraction model of the present method invention.

### DESCRIPTION OF THE PRESENTLY PREFERRED EXEMPLARY EMBODIMENTS

While the present invention is susceptible of embodiment in many different forms, there is shown in the drawings and will herein be described in detailed preferred embodiment of the present invention with the understanding that the present disclosure is to be considered as an exemplification of the principles of the present invention and is not intended to limit the broad aspect of the present invention to the embodiment illustrated.

The numerous innovative teachings of the present application will be described with particular reference to the presently preferred embodiment, wherein these innovative teachings are advantageously applied to the particular problems of an INTEGRATED OPERATIONS AND INFRASTRUCTURE MANAGEMENT SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Exemplary System Structure

### General Structure (3200)

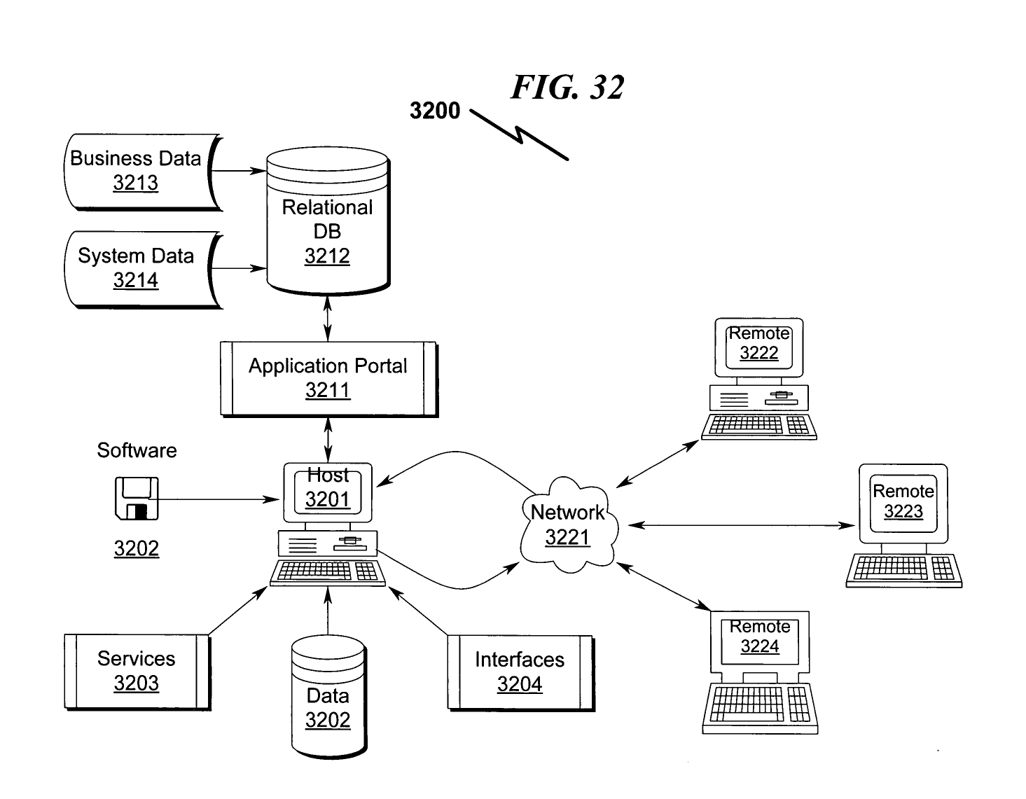

A generalized structure for the present invention is presented in FIG. 32 (3200), wherein a modular, multi-tier host computing system (3201) comprised of one or more relational databases (3212), web-based application portal (3211), software (3202), data (3202), services (3203), and interfaces (3204) to manage business infrastructure operations activities and data via transaction processing for a plurality of organizations within the operations of a business, enterprise, institution, agency, or other similarly formed entity that utilizes a combination of information technology systems. As generally illustrated in FIG. 32 (3200), this system may be accessed over a network (3221) by a variety of remote terminals (3222, 3223, 3224) via a variety of communication and presentation means, these being a web-based presentation over the Internet in many preferred embodiments.

### Major System Components

The present invention generally comprises a system structure including one or more of the following elements:

Relational Database Management Systems (RDBMS);

Software;

Business Database;

Data Families;

Data Associations;

Application Processes;

Business Process Description and Control Language;

Certificate Management System;

Security Management System;

Persistent Message Queuing System;

User Interfaces; and

Transaction Processing System.

These components are described in more detail in the following paragraphs.

### Relational Database Management Systems (RDBMS)

A Relational Database Management Systems (RDBMS) may provide persistent storage of data in a unique arrangement to provide composite control over application processes and data. The data included in the RDBMS may include business (3213) and system (3214) data.
1. Business data (3213)—this data represents information about the business including active, historical and transactional data classifications, comprising multiple data families, and encompassing one or more domains.
2. System data (3214)—this data is used by the software applications to control and manage the modules and processes including configuration, sessions, rules, roles, and services.

### Software (1100, 1200)

The present invention may include an aggregation of software designed to run on computing systems including but not limited to software applications designed to operate on (1) computing hardware without an operating system, (2) applications designed to operate within an operating system, virtual machine, application server, database, or client computing environment for the purpose of managing businesses infrastructure operations, as defined in this patent.
1. Services and Engines (1112, 1200)—Software applications that run or operate independently and provide various services including but not limited to certificate management, security, messaging, and other management systems. These components provide an application framework for modules and add-ons.
2. Modules and Add-ons (1113, 1300, 1400)—These components provide the specific functionality and features needed for a given business function or process.
3. Integration Components (0610, 1110)—Specialized applications that provide integration with other computing and database systems.

### Business Database (3213)

Data in the business database may be divided into the following classifications: active, historical, and transactional. These classifications are needed to segregate the information within the database for data integrity, storing temporal data, and providing transactional information.
a. Active data—this data represents the current (temporal) configuration of the business systems.
b. Historical data—this data is a copy of the active data prior to any change event along with a time stamp, trigger identifier (user, event or action) and any ancillary data that may have also been affected.
c. Transactional data—this data represents any transaction/event that may cause a change or work to be performed that could instigate a change to the active data. Transactions can include (1) requests to move, add or change a current configuration, (2) problems being reported by a user, administrator, or support representative, (3) a change related to a project or other large scale effort.

### Data Families

The active and historical data may be subdivided into four data families (primary, ancillary, type and characteristic).
a. Primary data—this data represents the core information needed to manage the collective group of data.
b. Ancillary data—this data represents additional data requested or required by the business to be tracked along with the primary data.
c. Type data—the type data is the data that provides constraints on certain fields in the primary, ancillary, and characteristic data.
d. Characteristic data—this data describes the characteristics of primary, ancillary, and type entries for software to facilitate pre-selection, decisioning, and translation.

### Data Associations

A unique identifier may be utilized in the RDBMS to associate data within a unique domain (1701, 1801, 2001, 3104) to ensure autonomy, segregation, and integrity. Data within the RDBMS must be encompassed in a domain by providing a unique identifier for the given domain in all primary and ancillary data in the active and historical classifications and all transactional data.

### Application Processes

Processes within the application environment may be managed by a System Manager. A configuration interface may provide mechanisms to add, change, and delete rules/configurations. The rules may allow specialized engines to process and control internal processes within the computing system. These rules may be stored in the description and execution language. Methods and processes may exist for monitoring and testing processes, reporting process-related events, and executing other processes and methods based on the events detected.

### Business Process Description and Control Language

A standards-based business process description and control language may facilitate tracking, displaying and controlling processes within the computing environment. The language may be utilized by various processes for decisioning, expressing requirements and configuring controls.

The process definition (1502, 3102) will use the business process description and control language to map an organizations process/activity including action creation, normal processing steps, validation, exception and incident handling, escalation, automated reporting and more.

### Certificate Management System

A Certificate Management System may be used within the present invention to ensure communications security, component authenticity, and user validation. A specialized engine may provide certificate management for the entire invention including generating and approving certificates.

### Security Management System

A Security Management System may provide the central control for the present invention. A specialized engine may provide a central mechanism for authorization and authentication for sessions, users, modules and messages by utilizing a combination of rules and certificates.

### Persistent Message Queuing System

A persistent Message Queuing System may be utilized to traffic session data and facilitate other communication between a plurality of computing services and systems. This persistent system may be provided by a specialized messaging engine to facilitate message storage and processing.

### User Interfaces

A plurality of user interfaces may be provided for administration, configuration, and normal usability.
a. Administration—special interfaces may exist to manage the present invention including establishing communication parameters, database management, monitoring, logging, process management, and management of integration components.
b. Configuration—special interfaces may exist for configuration of roles, rules, domain, certificate, security, messaging and interface configuration.
c. User—special interfaces may exist for five categories of users. Each interface may be designed to facilitate the needs from the user's unique perspective, with varying degrees of complexity, flexibility and predetermination.
   i. End-user—these interfaces may provide request and problem management, reporting, billing, and user-specific configuration for users external to the infrastructure/facilities and/or services organization that may facilitate resolution or completion of the request/problem.
   ii. Technicians—these interfaces may provide request, problem and change management for the transactional processing system to users internal to the infrastructure/facilities and/or services organization that manage the business, service or facility affected.
   iii. Administrators—these interfaces may provide tools to schedule, plan, coordinate, delegate, and alter requests, problems and changes within the transactional processing system by administrators internal to the infrastructure/facilities and/or services organization that manage the business, service or facility affected.
   iv. Support—these interfaces may provide support organizations (internal or external to the infrastructure/facilities and/or services organization that facilities the management of business, service or facility affected) with visibility to all activities within the transaction processing system, as well as, provide technical information to support personnel about equipment and configurations that may impact said service, facility or user.
   v. Management—these interfaces may provide multiple levels of management (line, mid-level, and executives) with interfaces needed for reporting, tracking, controlling, and managing. The interfaces may support users internal or external to the infrastructure/facilities and/or services organization that facilities the management of business, service or facility affected.
      1. Reporting—the present invention may provide automated and on-demand reporting mechanisms that can be viewed or printed. This mechanism may utilize the process description and control language to provide any combination of predefined or customized report.
      2. Recovery—the present invention may provide automated and on-demand recovery mechanisms. These mechanisms may be configured using the process description and control language.
         a. Cost—The recovery mechanisms may provide cost recovery through traditional and automated billing utilizing any combination of billing requirements that may be stored in the process description and control language.
         b. Resource—Recovery mechanisms may also exist to facilitate recovery of resources freed by attrition, change, or other business processes.

### Transaction Processing System

Transaction Processing System—A transaction-based system for processing requests, problems, and/or changes may be utilized to facilitate management of the business data. All processes may be tracked through the duration of the transaction life-cycle, and reports and other analytics may be available for recovery and other uses.
1. Request—the present invention may support non-problem related requests from end-users and managers to add, alter/change or delete/remove services within the infrastructure. Requests involve small-scale completion of normal service-level agreement, and do not require any level of root cause analysis. Requests also, typically, only affect one service/support organization, can be completed without creating outages, and do not require budgeting to facilitate completion.
2. Problem—the present invention may support resolution of problems detected/reported by any level of user. Problems are events that cause loss of work due to failure or outage, and should require a root cause analysis for future prevention/mitigation.
3. Resource Allocation (change)—the present invention may support other resource requests. These requests include allocating human, equipment, and other physical resources for large and small-scale (daily) needs. Resource allocations for large-scale projects that may affect one or more service/support organizations, may cause outages during completion, and/or may require special budgeting to facilitate completion. The present invention is able to determine the availability of the resources, aid in scheduling, help identify conflicts, and ensure proper communication with appropriate groups and individuals based on other data stored within the business data and rules.

### Architecture

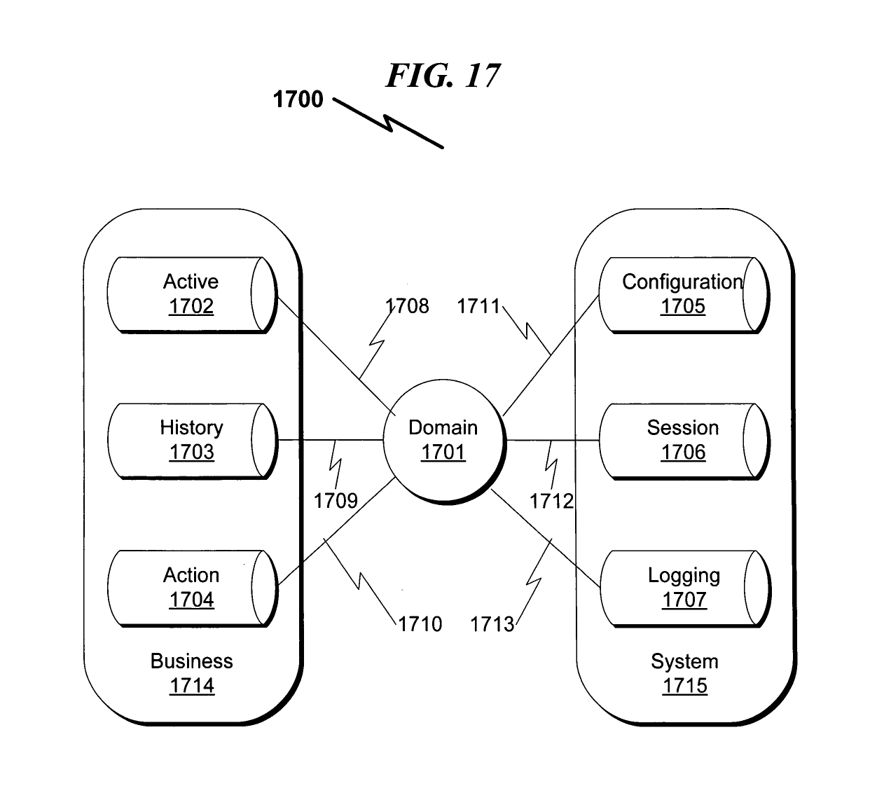

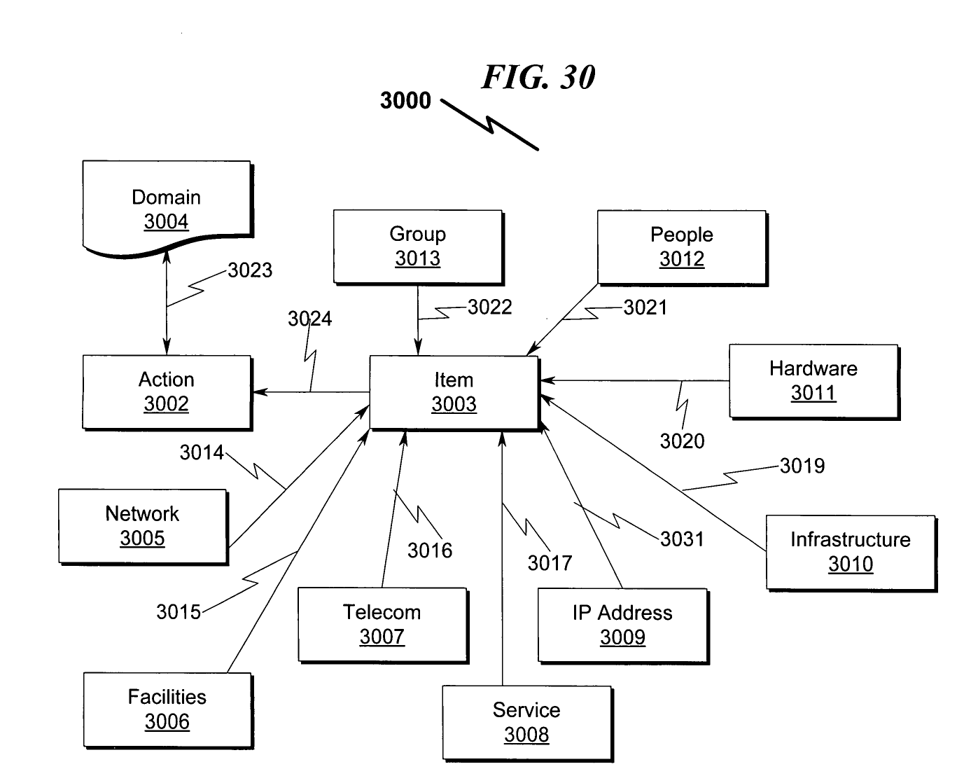

The architecture of the present invention contains data stored in one or more relational databases (0611, 0923, 1101, 1407, 1505, 3105, 3212, and detailed in FIG. 17 (1700)-FIG. 30 (3000)), web-based and non-web based user interfaces (0600) provided by an aggregation of software, automated processes and a transaction processing system (0506, 0608, 0800-1000). A standardized interface is defined for modular components (1113, 1300, 1400) to be incorporated. A process description and control language may be utilized to support flexibility, configuration, and modeling of processes. Persistent messaging is utilized for inter-process communication. Various other processes and components provide automation and integration (0610, 1110) with external systems/subsystems.

The present invention takes into account the changes in technology that may occur over time. Because of the modular and flexible nature of the present invention, it may also be possible to support management of these newer technologies (0307).

### Standards

The present invention may use open and/or proprietary standards for communication, language, architecture, and/or storage. Also, the developers may develop and publish new standards as needed. Utilizing existing standards only provides a path/method to simplify and expedite module development, communication, and/or design. While it is prudent to use standards, if they exist, the present invention does not specifically require any of these standards to function.

The Open Systems Interconnect (OSI) Reference Model is accepted and understood industry-wide as an abstraction for layered communications and computer network protocol design. It was developed as part of the Open Systems Interconnection (OSI) initiative. In its most basic form, it divides network architecture into seven layers that, from top to bottom, are the Application, Presentation, Session, Transport, Network, Data-Link, and Physical Layers. The present invention references this model to ensure it is understood that the present invention may support any network technology or combination of technologies that fit the reference model.

Extensible Markup Language (XML) is a general purpose specification for creating customized/specialized markup languages. It is classified as an extensible language, because it allows the user to define the mark-up elements. XML's purpose is to aid information systems in sharing structured data, especially via a network, to encode documents and/or data, and to serialize data. Again, it would be prudent for the present invention to use XML or similar mark-up technology, but it is not required.

### Platform

The present invention may be implemented in numerous ways, but the current preferred architecture employs an application server/servlet (1111, 1206). Many standards exist for application servers and servlets. The present invention may be designed to be deployed on almost any application execution environment, including those based on industry standards, as well as, any alternative/proprietary platform. Functionality may be gained/lost when choosing a platform, due to the features/limitations of the application server platform.

The present invention is designed to primarily be deployed on a computing system directly attached to a company's network. While an implementation of the present invention may be built to be deployed on a remote computing environment, the lack of network connectivity prevents much of the necessary communication to external devices and equipment. Many of these limitations can be overcome through network modification and/or manual processes. However, the latter may contravene some of the benefits (automation) the present invention is designed to provide.

### General Design

The design of the present invention focuses on providing an extensible system that facilitates automation, communication, integration, flexibility, modularity, persistence, integrity, accountability, security and control through proper interfaces for the users.

### Extensible

The present invention includes a layer of abstraction and modularity to support future variances and changes in technology, business practices, government regulations, and culture. Given these changes, any specific technology, such as IPv4 addressing, may be included in the implementation and the design allows the successor, such as IPv6, to also be managed by the same implementation. Similarly, standards such as XML are likely to be used in a given implementation as the description and control language. However, future changes may force module developers to use other standards. Thus, the present invention embodies the ability to support the current technology and standards as well as any future changes and/or requirements.

### Automation

Automation is provided through a series of engines (1209) that are programmed to look for issues or any other activity based on programmable criteria, report findings, and automatically recover when possible. Using a description and control language, discussed later, module designers and users can construct complex processes that execute continually or on any schedule. Dividing these functions into separate components is prudent, as it helps to eliminate contention and ensures the computing system can continue monitoring even when other issues have occurred, but is not required.

### Integration

In almost all deployments/implementation of the present invention it is necessary to integrate with other computing systems. To facilitate this integration, unique components must be developed to interface with support tools (0209, 0217), databases (0213-0216) within the organization, and other enterprise applications used outside (0301) of infrastructure operations (0305). Integration components (0610, 1110) can be prepackaged to support common architectures like other databases (Oracle, DB2, Sybase, etc.) or proprietary enterprise applications like PeopleSoft, SAP, and more. Custom components can also be created to interface with other open-systems and internally developed solutions. These components can be written in a multitude of languages, and may circumvent the security. Therefore, it is critical to properly design these components, and control access and execution.

### Flexibility

The present invention is designed to support any combination of business requirements/needs, yet maintain control, persistence and integrity. A description and control language provides the majority of the flexibility by providing an abstract mechanism for businesses to control process and message flow.

Flexible enterprise applications require a degree of configuration, and frequently this takes the form of proprietary configuration/properties files (1408) each with a unique design. The use of business process description and control language standards can be adapted to provide a cleaner, well-defined mechanism for both configuration and displaying/representing the process(es) graphically. Some standards may require minor modifications to support newer business process requirements. Use of these standards can effectively provide configuration and execution controls (automation) for reporting, monitoring, and recovery.

The present invention may also be designed to support a plurality of languages, internationalization, and localization options. For languages, the industry standard method is to use indexed resource data to look up string translations, and double-byte character sets within the database. To properly support these options, the module/interface designers should utilize the default options stored in the profile tables (1807), but they should also query the user preferences stored in the configuration (1705) and system (1706) data, if available.

### Modularity

The architecture of the present invention is centered around a group of interfaces (user and application) and services, exposed/provided by a combination of core modules (1113, 1300, 1400), that provides a framework for a modular design. This modularity supports developing/delivering new products and features, as well as, allowing businesses to choose which modules they need/require.

Modules should be signed by digital certificates, and the present invention may validate the certificate using a certificate authority (1201), or other acceptable method of validation, before the module object code is executed.

### Persistence

To ensure overall proper system function even in the event of a hardware malfunction/outage, the present invention utilizes computing mechanisms that provide persistent storage and communication, in case of a non-catastrophic computing system failure. A relational database (0611, 0923, 1101, 1407, 1505, 3105, and detailed in FIG. 17 (1700)-FIG. 30 (3000)) is used to provide persistence and integrity for data storage. For most inter-module/inter-process communications and session/transaction management, any persistent messaging systems can be used. Utilizing persistent messaging, instead of traditional inter-process communication/remote invocation calls can prevent loss of data and ensure activity continues upon recovery. Similarly, the automation components (1209) should be able to access and manage processes by querying the queue manager, and provide automated escalation, notifications, and recovery (cost or resource).

### Integrity

The present invention is designed to provide metrics and measurements of operations activity and performance. Therefore, the data this information is derived from must be accurate. Persistence ensures the data remains in tact, but the present invention must also be designed to ensure the data can not be corrupted. The two key/critical considerations for integrity are in the design of the relational database system (0611, 0923, 1101, 1407, 1505, 3105, and detailed in FIG. 17 (1700)-FIG. 30 (3000)) and the handling of data by the modules.

The design of the database is critical to integrity by enforcing constraints on the data. Constraints include judicious use of unique identifiers and references to other data.

Due to the current design of relational databases, and computing systems in general, in many languages it is necessary for much of the data to be stored in a common case. All primary key data fields should either be numeric or case-shifted to enforce integrity. Because, according to common normalization rules of RDBMS, all of the primary keys must be specified in a foreign-key relationship. Therefore, all of the referent fields in the child table should also be case shifted accordingly. Parameters can be set in a profile (1807), property (1408), or configuration (1705) to control this action.

To ensure accurate data is entered, most data entry fields may either have programmable constraints or may use other data from the database to populate the selection. Where possible, free-form text should not be stored except where cultural convention and business needs dictate.

In addition to the referential integrity provided by/within the database, business units need mechanisms to validate the accuracy of the business data. Throughout the operation/use of the present invention, the data may be utilized for automation, reporting, and intelligent processing. Therefore, the accuracy and validity of the data is critical. Technicians provide a modicum of validation during their day-to-day functions. When processing transactions, if the technician determines the data is incorrect, they can use their special application interface (0609) to correct the data and report any unauthorized activities.

Separate processes can also be run to communicate with disparate enterprise systems. These integration components (0610, 1110) can be created to support transferring data between the present invention and external data sources (0302-0304). Also, some devices (0308, 0310-0312) have mechanisms that facilitate communications and discovery. Leveraging this technology can also yield additional information that technicians (0203, 0604) and administrators (0204, 0602) have traditionally ignored or overlooked. This additional information can provide intelligent insight into any number of problems including security issues, undocumented changes, and problem avoidance. However, consideration must be given for the source of the data, and rules must be defined to interpret the data.

### Accountability

The present invention is designed to ensure that the appropriate group(s) (0105-0110) are responsible for maintaining the information about their respective facility or service. This removes the burden from other organizations to manage/maintain data outside of their purview.

Conversely, all of the events (or lack thereof) are recorded by the present invention in historical data and/or logs. This is provided both for measurements of activity as well as reporting actions and activity (both intended and nefarious). In many cases, the failure to properly update the database (0611, 0923, 1101, 1407, 1505, 3105, and detailed in FIG. 17 (1700)-FIG. 30 (3000)) and/or circumvent using the proper tools/mechanisms may not be recorded. However, the detection of inconsistencies can help identify the weaknesses within the business processes.

### Security

Given the importance and impact of the present invention to a business, security is paramount. Many levels of security are required to adequately manage access, and the foundation for that security should be certificate management (1507). Certificates (such as ITU-T X.509) can provide validation for modules, messages, and other forms of communication. The same certificates can provide single sign-on for users and digital fingerprints for transactions and other activities. Therefore, a certificate management engine is necessary to establish a central agent for validating and generating certificates.

### Control

The present invention is designed to provide an unprecedented level of control, which in itself requires a great deal of control. The description and control language is designed to facilitate much of this control by defining process flow in a process definition (1502, 3102).

There can be any number of control points defined within a process to generate notifications and require approvals.

### Communication

Lack of communication is one of the major short-falls of other enterprise software systems used in infrastructure management. The present invention includes methods and mechanisms to facilitate communication between users, components and other software/application systems.

Communication to users is a critical aspect of the present invention. The present invention may use or include any combination of standard and/or proprietary communication methods/mechanism for communication to the user. These may include but are not limited to email, instant messaging, web feeds, and printing. One of the most common forms of communication to users is reporting. Reporting can include any combination of raw and formatted data. But typically, reports provide accumulated/aggregated data into meaningful representation for the recipient(s).

Communication between components is also integral for the present invention to function properly. The present invention may use any combination of standard and/or proprietary communication methods/mechanism for communication between applications (0601), modules (1113, 1300, 1400), and external systems/subsystems (0610). Most communication should be persistent to ensure that, once a message is sent from one module or process, the module developer should be reasonably certain the message is delivered or handled properly.

### Messaging

The basic form of communication between modules/components is messaging. Messaging involves defining one or more local and/or remote queues on a messaging server/engine. The messaging engine (1202) controls the queue manager (3103) that provides the mechanism to support transporting and storing the messages in a queue (3106). The messaging engine should provide methods/interfaces to request the creation, modification or deletion of a message queue, as well as placing messages on a queue and/or removing/consuming messages from a queue. The messaging engine should also provide methods/interfaces for querying/monitoring queues. The automation components (1209) may use this ability to monitor queues to detect messages that are not being delivered, processed, or are not properly encrypted. The messaging engine can similarly send messages or trigger events for the monitoring engine. Finally, the messaging engine should provide methods/interfaces to search for a message queue by any combination of parameters.

### Reporting

Reports provide meaningful information to users about the business and/or processes and activities within the business, which is a critical function within all enterprise organizations. Some prior enterprise applications provide a modicum of reporting. But the added visibility, accuracy, and granularity of the data about the infrastructure, services, and activities, within the present invention, can provide an unprecedented level of reporting capabilities. Thus, the present invention provides mechanisms and methods to generate a plurality of reports. The present invention may support on-line (web-based), email (text, PDF, or raw data), and printed reports. These reports can be produced on-demand and/or automated. The reports can be stored (canned) for repeated retrieval or generated ad hoc. The purpose of these reports can include billing, planning, and notification. The present invention also supports dashboards that are considered a special form of report providing a combination of real-time and trend-based meters/indicators for performance analysis.

Notifications are a special form of reporting required for transactions to be processed by appropriate groups (0916-0919) and managers for positive and/or negative confirmation/approval. Positive confirmations are the traditional approval mechanisms whereby processes are stalled until approval (0911) is granted or the action is rejected/canceled (0910). The present invention uses negative confirmation when the process does not necessarily require approval, and the manager/approver has sufficient time to provide their dissent.

### Users (0600)

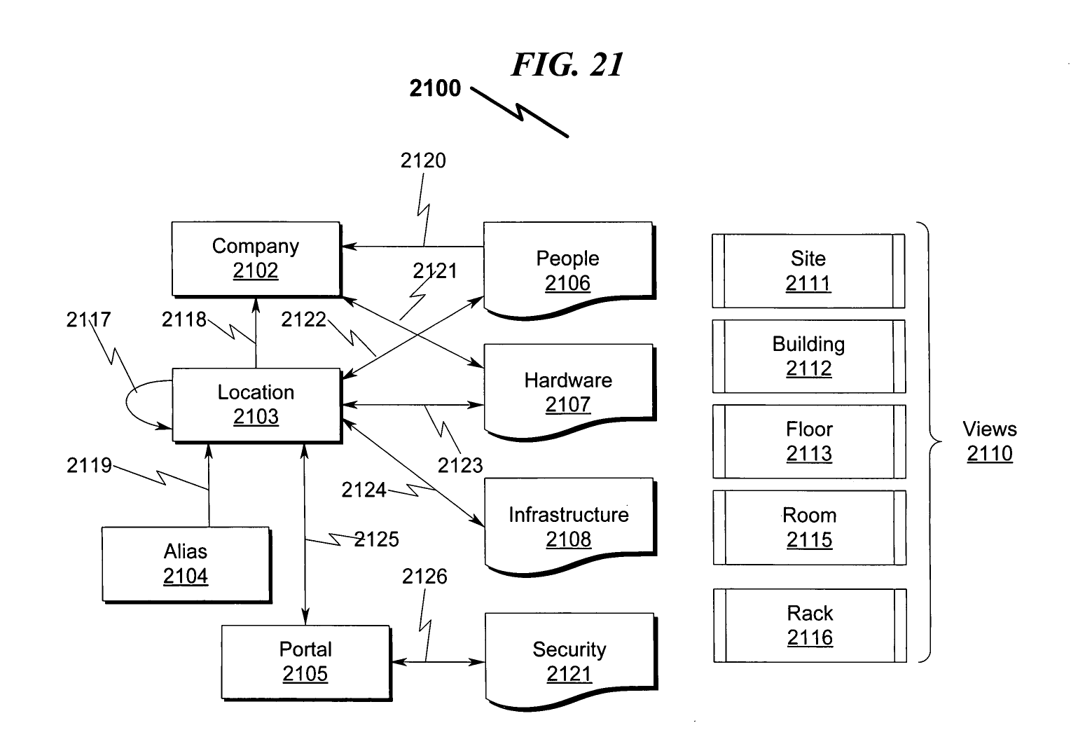

As stated before, one of the key weaknesses of the prior enterprise software systems is that they do not realize or support the need for unique interfaces optimized to meet the needs of each class of user (0602-0606). Within any business, there are five (5) distinct classes of users (see FIG. 21), so module designers may need to consider the unique business, technical, and efficiency needs of the users for that module. Most modules (1113, 1300, 1400) may have more than one interface to support each class of user. The interface to be displayed may depend on the authenticated credentials of the user.

The most common interface for all users is the transaction processing system (0506, 0608, 0800-1000). This portion of the system may handle the majority of requests and problems from external users, that may be processed or serviced by the internal users. Because the TPS facilitates the bulk to activity, it is also important to managers for cost and resource recovery.

These user classifications are:

1. End-users

2. Technicians

3. Administrators

4. Support (Help Desk) Personnel

5. Management

### End-Users

End-users (0605, 1512, 1611 & 3112) are external to the infrastructure/facilities and/or services organizations that manage the facility or service. These users range in technical understanding, but largely are not proficient enough to adequately support their own infrastructure and IT needs. Creating tools to empower these users to affect common changes would provide a significant cost savings to most companies. Similarly, tracking usage and volume of work would give management (0606) an alternative metric for billing and cost recovery. Tools designed for the end user are designed to help the user through the process of submitting a request/problem, and manage their expectations throughout the delivery/resolution process.

### Technicians

Technicians (0604, 1514, 1614 & 3114) are internal to the infrastructure/facilities and/or services organization that manage the business, service or facility affected. These are usually highly-skilled workers who require efficient means of entering, updating, and managing the data for the services/infrastructure they support. These users rarely enter requests, but they are the focal point for problem resolution. They also may require scheduling, delegation and administration to support their efforts. Technicians also initiate change within their infrastructure, usually to support changes in technology or End-user/business requirements.

### Administrators

Administrators (0602, 1515, 1615 & 3115) are also internal to the infrastructure/facilities and/or services organization that manage the business, service or facility affected. Their function is less technical than the technicians, but they are frequently the users who schedule, plan, coordinate, delegate, and alter requests, problems and changes within the transactional processing system (TPS). Often times, they may act as representatives for their organization to other business units.

### Support (Help Desk) Personnel

Support personnel (Help Desk) (0603, 1516, 1613 & 3116) users provide support (internal or external to the infrastructure/facilities and/or services organization that manage the business, service or facility affected) with visibility to all activities within the transaction processing system, as well as, provide technical information to other support personnel about equipment and configurations that may impact their respective service, facility or customer. The support personnel are focused on customer care, and mitigating the need for technicians (0604) in problem resolution. Support teams are frequently structured in a hierarchy with the upper levels being supported by technicians. Many problem management systems utilize tickets to track problems, therefore this paradigm may be somewhat mirrored in the transaction processing system.

### Managers

Managers (0606, 1513, 1612 & 3113) are both internal and external to the infrastructure/facilities and/or services organization that manage the business, service or facility affected. Their needs include reporting, tracking, controlling, and managing the business. Multiple levels of management exist including line, mid-level, and executives. These users range in technical knowledge and may require support similar to that given end-users (0605). Like technicians (0604), they require tooling that is efficient to use.

### Interfaces

The present invention has a number of different interfaces (0600), and each module (1113, 1300, 1400) and/or application (0601) can add many more. The three general classes of interfaces are web-based (application server or servlet), command-line, and free-standing applets and applications. The decision on which is preferred depends on the underlying platform/architecture, available technology, and business needs.

### Web-Based

Web-based interfaces provide less maintenance than free-standing applications, but may be limited by constraints in performance and robustness. Most modules may still employ web-based interfaces, for the end-users and simple administration tasks. A application server or servlet (1206) may provide multiple interfaces using rich Internet application architecture (RIAA). Rich Internet applications are designed to connect the client platform with the server platform via web-standard technologies.

### Free-Standing Applets and Applications

Some modules may require applets and applications to execute on the user's (client) computing platform. These applications can be designed to be platform dependent, and may provide increased performance or robust functionality. Applets mitigate many of the risks and problems associated with platform-dependent interfaces, and even provide some level of additional control.

### Command-Line

Command-line applications are non-graphical interfaces that typically execute out-side of the application server environment. Generally these may include tools to start and stop the system manager module, manage the RDBMS and/or computing hardware, and perform low-level administrative functions.

### Dashboards

Dashboards are a general class of interface that provide a high-level overview of the status of the computing system. Dashboards may be used in the present invention to provide specific information to/for any group. Some dashboards can be web-based using any combination of RIAA and/or applet technologies.

### Service Interfaces and Data Feeds

Service interfaces are network-based communication channels that support interoperability between modules and/or computing systems. In addition to traditional web technologies, other web services and data feeds can be exposed. These technologies can provide additional mechanisms for communicating internally and externally of the present invention including application programming interfaces (APIs).

### Transaction Processing System (TPS)

The infrastructure of a business is continually in flux. Therefore, the infrastructure operations business units need a common system to track, manage, and process requests, problems, and resource allocations (0313-0315, 0401, 0502-0504) to the business. This system should provide all users with a single, straight-forward, and intelligent interface for submitting requests and reporting problems. In addition to servicing, scheduling, and processing end-user (0605) problems and requests, technicians (0604) and administrators (0602) need the ability to track and manage major changes to the infrastructure. The transaction processing system (TPS) (0506, 0608, 0800-1000) provides these interfaces, methods, processes and mechanisms to measure and track the activity and the subsequent events in the business. Some operational/business support systems include a level of transaction processing, but to completely meet the needs of all business units the software must include support for request, problem, and/or change management. The TPS is one of the most important modules (1113, 1300, 1400) of the present invention because it provides the mechanism for generating, processing, reporting, and recovering most day-to-day activity. Through the course of completing/remediating the transactions, the active (1104, 1702) and historical (1105, 1703) business data (stored in the database) is updated, logs are kept, notifications are sent, and reports are generated.

### Requests (1005)

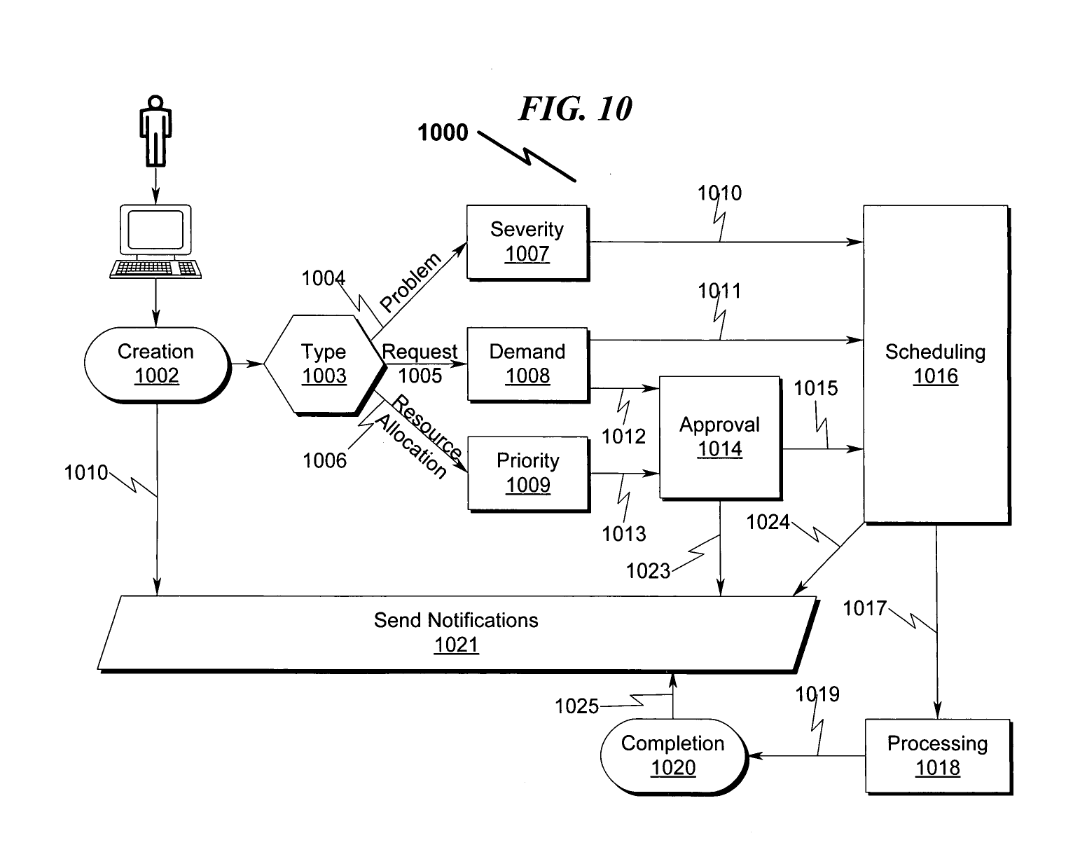

Referencing FIG. 10 (1000), requests (0502, 1005) are day-to-day transactions created (1002) by end users and managers for standard services. These forms of transactions can be classified/prioritized by the relative time required to complete and/or the importance of the requester within the business, which can be referred to as demand (1008).

However, these requests are predominantly prioritized in first-come-first-served order. Requests may sometimes requires a myriad of approvals (1014), that can change at any time.

### Problems (1004)

Referencing FIG. 10 (1000), problems (0503, 1004) are transactions created by any user to report situations/problems with a facility/service that already exists. Problems are generally classified by severity. The severity (1007) is usually determined by the impact of the issue and is summarily prioritized and resolved depending on business Service Level Agreements (SLAs). Because these transactions involve established services, resolution rarely requires approvals (1014). However, notifications (1021) may need to be sent to a variety of management groups.

### Changes (1006)

Referencing FIG. 10 (1000), changes (0504, 1006) are major alterations to the facility and/or services. These changes generally coincide with a formal project, require capital planning, involve more than one internal business unit, and take a significantly longer period of time to complete. The key to changes are coordination of resources through effective communication and resource allocation. Changes may almost always require approvals (1014) from various managers, stakeholders, and other approvers. Notifications (1021) must be sent to personnel who are both internal and external to the involved operations units.

### Transaction Management

With these common needs in mind, related business units/organizations must coordinate their request, problem, and/or change management activities to ensure effective coordination and processing of these transactions. By including more than one organization, visibility is given to others about any change in status, scheduling, or other aspect with may have a cascading effect. Historically, facilities management groups do not coordinate with other business units, even when they do employ some form of problem or request management system. Using the integral transaction processing system, facilities management may be cooperatively managed on the same platform. This allows the other operational units to have visibility to the changes that affect the infrastructure for which they provide services.

The transaction processing system also provides a greater level of granularity of operational activities, allowing businesses to recover costs and resources. Historically, IT operations and facilities management has been considered a veritable black hole for finance managers, typically because few if any mechanisms were available or employed to accurately measure productivity and performance of business processes to an adequate level of granularity. Without having adequate granularity to events, managers of these organizations were not able to provide metrics for managerial accounting. Without these metrics at the line level, subsequent mid-level and upper-level management and executives were not able to effectively measure, develop strategies for, and plan operational activities. When this situation occurs, most businesses will over-architect the infrastructure to compensate for the inability to adequately and properly measure performance.

### Method (3300)

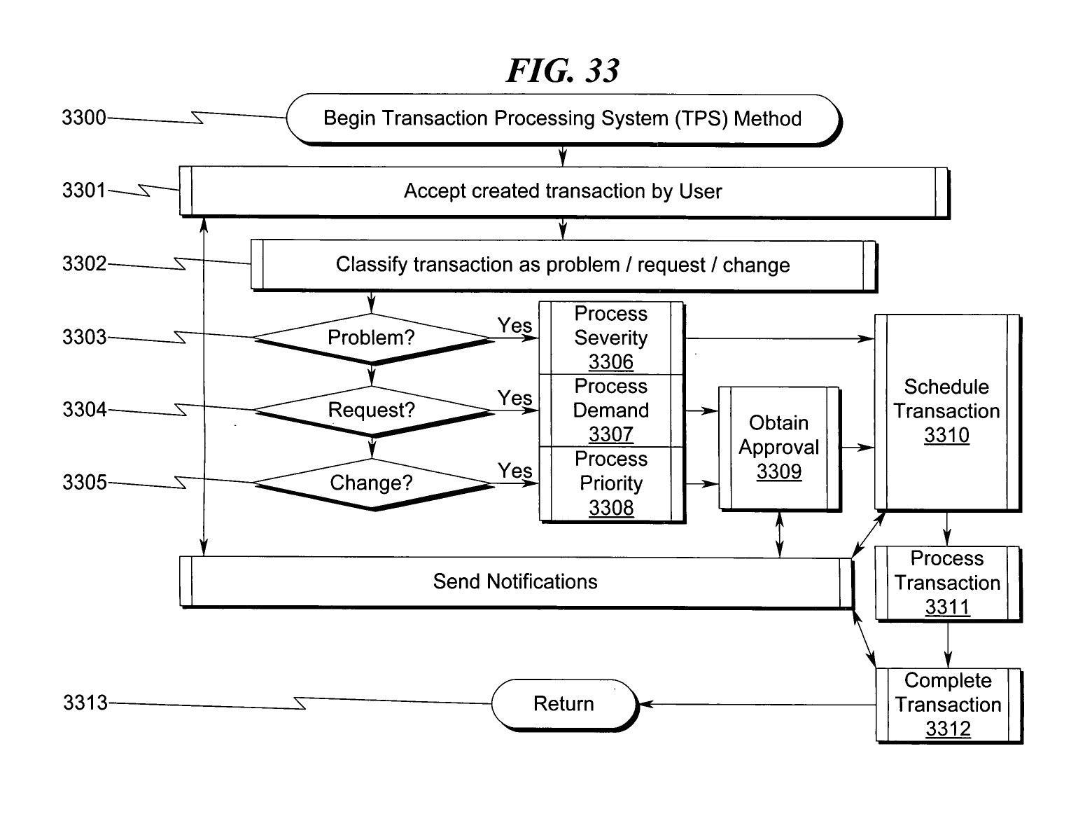

The transaction processing system generally illustrated in FIG. 10 (1000) may be implemented as a method utilizing computer hardware as generally illustrated in the flowchart of FIG. 33 (3300). This method as applied to the transaction processing function typically involves the following steps:
1. Accepting a transaction created by a system user (3301) and sending appropriate notifications;
2. Classifying the transaction as a problem, request, and/or change (3302);
3. If the transaction is a problem, proceeding to step (6) (3303);
4. If the transaction is a request, proceeding to step (7) (3304);
5. If the transaction is a change, proceeding to step (8) (3305);
6. Processing the transaction severity and proceeding to step (10) (3306);
7. Processing the transaction demand and proceeding to step (9) (3307);
8. Processing the transaction priority and proceeding to step (9) (3308);
9. Obtaining necessary approvals for the transaction (3309) and sending appropriate notifications;
10. Scheduling the transaction for execution (3310) and sending appropriate notifications;
11. Processing the transaction for execution (3311) and sending appropriate notifications;
12. Completing the transaction (3312) and sending appropriate notifications.

One skilled in the art will recognize that these steps may in some circumstances be rearranged, modified, expanded, or limited with no loss of function with respect to application in the field of transaction processing systems.

### Profiles and Characteristics

Profiles (1807) and characteristics (1806) refers to data contained in the database (0611, 0923, 1101, 1407, 1505, 3105, and detailed in FIG. 17 (1700)-FIG. 30 (3000)) that is used by the application to make logical decisions.

Profiles (1807) are typically needed to define the basic configuration parameters and assign important variables. Profiles generally exist for each domain (1701, 1801, 2001, 3104), module (1113, 1300, 1400), location (1903, 2004, 2103), and company (1902, 2003, 2102).

Characteristics (1806) are definitions of certain types of hardware/devices (1909, 2010, 2900) stored in the database. This prevents module designers from needing to store hard-coded information about every make and model of equipment/furniture. By defining key characteristics, the module designer can then utilize this information for a myriad of purposes.

### Session Management

When a user (0602-0606) accesses the application, they should generally be required to log in through an approved authentication method. Once the credentials are verified, their respective information can be retrieved, and the appropriate interface can be displayed. Their information can be stored on their client platform and retrieved by each module (1113, 1300, 1400), that provides a convenience to the user by not requiring them to authenticate with each module. Additional information can also be stored about the user's activities, including the details of any transactions they submit. The session information can then be stored on the server, recalled and modified by other users and processes.

### Business Process Description and Control Language

To support the ever-changing myriad of business process requirements, the present invention must utilize a business process description and control language for both process modeling and execution. The present invention may use any combination of proprietary and/or standards-based formats, including hybrid designs. The language(s) may also be used in all configurations for the present invention for process definition (1502, 3102).

### Modeling

The description and control language may include information to display the process graphically. Additional data can be stored to set controls for processes as they execute, such as approvals, notifications, and escalations.

This information can also be used to determine the costs (time, money, and resource) associated with a given process. This information can then be merged with the metrics and measurements provided within the present invention to create an accurate analysis of the costs associated with each business process.

### Execution

The description and control language may also be used by the monitoring engine to trigger events. The language may allow for testing criteria, monitoring process times/execution, and scheduled process execution.

### Database Design

The relational database design (0611, 0923, 1101, 1407, 1505, 3105, and detailed in FIG. 17 (1700)-FIG. 30 (3000)) is critical to ensure integrity and persistence. Additionally, the relational database system (RDBMS) performance is critical to ensuring the proper operation of the present invention. Numerous techniques can be utilized to ensure the performance is adequate for the business including placing the database server on one or more separate computing systems (clustering), indexing, partitioning, placing the data on high-speed storage devices/media, data caching and connection pooling.

To intelligently utilize the data, and achieve the present invention's infrastructure operations management goals, requires a very carefully and specifically designed relational database system and comparably designed software. Additionally, it is necessary to recognize a strategy for separating the data to provide integrity, flexibility, and other characteristics necessary to effectively manage operations as a whole. Two distinct classes of data are:
1. Business data (1102, 1714)—This is data about the business, infrastructure, hardware, services and security. This includes the active (1104, 1702), historical (1105, 1703), and transaction (1106, 1704) data.
2. System data (1103, 1715)—This is data that includes session information (1108, 1706), configurations (1107, 1705), and logs (1109, 1707) relative to the application/invention itself.

One portion of the business data must contain the current active (1104, 1702) configuration. This data cannot be intermingled with transactional and/or historical data. This approach requires looking at the temporal aspect of the business data, and understanding how the data mutates/changes over time. This precept derives from the fact that, at any given point in time, only one reality can be true about the configuration of the business operations. There may be transactions in progress to change the configuration. But, at that instant, the data is fixed. Summarily, after the data is altered, a backup copy of the data must be maintained along with a time stamp, identification, and other relevant information about the user or transaction that instigated the change. This historical record, along with the record of the transaction itself, can be used to provide the visibility to the activities within the operational unit.

Next, one must understand that, within operations, there are key/primary (1802) elements of data that are universally common and required to accurately and effectively manage the business data. Also, there are an infinite number of additional, ancillary (1804), unique elements that may be wanted or needed by that specific business organization. Establishing separate containers for the primary and ancillary data, with appropriate constraints, allows for flexibility without sacrificing performance or integrity.

Often data elements are needed to provide constraints on valid entries within the database. By establishing these referential constraints, the present invention ensures the validity/integrity of the information/data. Summarily, by managing the data about the infrastructure/facility within the present invention, other operations units have an accurate record to validate the physical location of their assets/resources. Similarly, feeding necessary human resource information to the present invention, regardless of interval or scope, may provide a foundation for the ownership of resources, reporting structure, and validation of users. Other data must be provided by the internal users (0505) to establish fundamental boundaries/rules for the implementation. This includes types of ancillary data, equipment, status and more. Additionally, a special subset of data can be defined to describe the characteristics of a given type of device/equipment or other entity. Storing this characteristic data can then provide the foundation for database-driven development.

The management of infrastructure operations requires several key elements. To start with, IT service providers must know about the infrastructure in which they provide their services. To effectively manage the infrastructure operations, the present invention must have information about the people (individuals and groups) using the application, referenced in the database, and/or utilizing the services. Also, the database must accurately store (and the application must properly utilize) information about the location (site, building, floor, space/room, racks and other identifiable locations). Because enterprise systems are typically centralized, among other reasons, the data must also include a domain element (1701, 1801, 2001, 3104) to constrain and relate the data appropriately.

### Minimal Requirements

The database system selected must meet a few basic industry standards in order to function properly, especially for the business data.

### Intra-Schema Referential Constraints

The RDBMS must allow for complex naming of tables. The table name should include both a schema name and a table name. Some RDBMS systems abstract the concept of a schema by creating separate database containers for each schema. The business data relies heavily on relationships between different schemas, and RDBMS's that do not support these relationships can cause integrity issues. However, complex naming schemes can be utilized in these systems to overcome their limitation.

### Locking and Isolation Levels

The databases (system and business data) may see a high volume of transactions that may cause contention and performance issues. Certain RDBMS systems allow row-level locking and alternative locking schemes to prevent contention. For optimal performance and integrity, the RDBMS should support either repeatable read and/or read committed isolation levels.

### Data Families

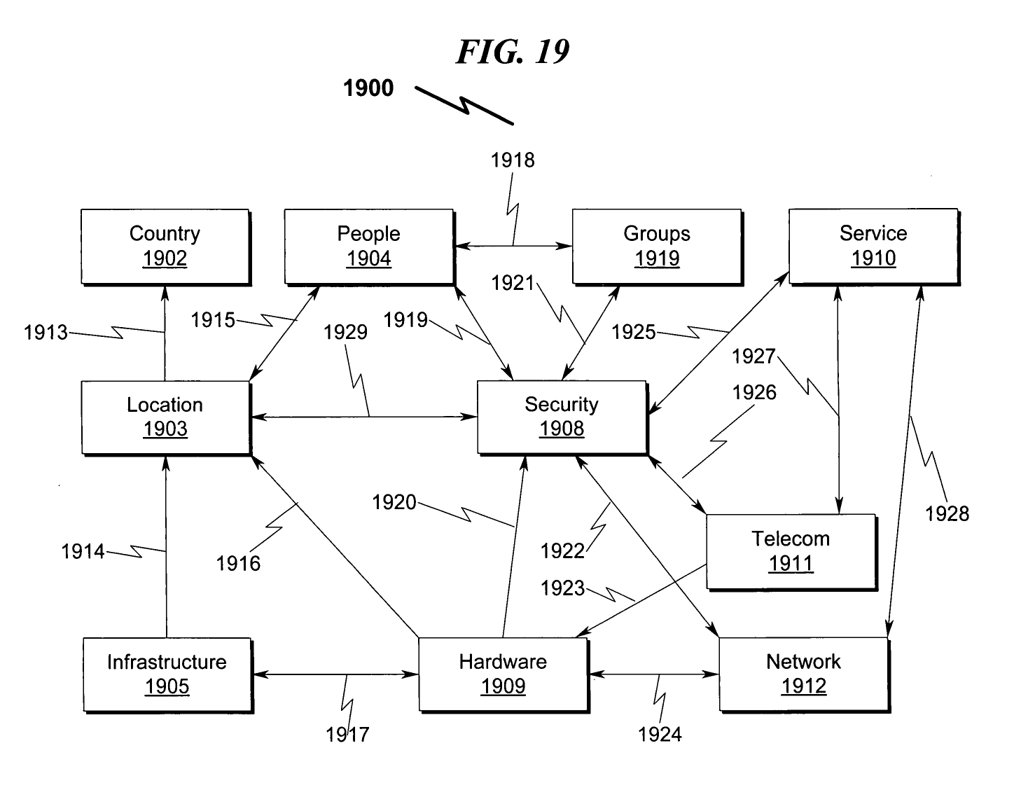

As shown in FIG. 19 (1900), the business data (1102, 1714) should be grouped (1800), and each group may include primary (1802) and ancillary (1804) tables. Optionally, the groups include any number of type/status (1803) and characteristic tables (1806).

### Primary Data

Primary data (1802) represents the core information needed to manage the collective group of data. The primary data fields are unique for each family of business data being defined/captured. Typically, the primary data includes the domain ID (a reference to the domain table (1801), a unique ID or other uniquely-defining characteristics, and one or more type and/or status fields.

### Ancillary

The ancillary data (1804) represents additional data requested or required by the business to be tracked along with the primary data (1802). This table can be structured to support an infinite number of types of data, and only limited by the entries in the type table.

### Type and Status

The type and status data (1803, 1805) is the data that provides constraints on certain fields in the primary (1802) and ancillary (1804) data. Typically, this data includes a unique identifier, a description, and a key/identifier that can be used to reference code and/or translation data.

### Characteristic

Characteristic data (1806) describes the characteristics of primary, ancillary, and type entries for software to facilitate pre-selection, decisioning, and translation. Not all groups include characteristic tables.

### Profile

Profile data (1807) is data that describes unique rules, configurations, or parameters related to the primary data. This is usually used in relation to a location, company, group, or domain.

### Data Classifications

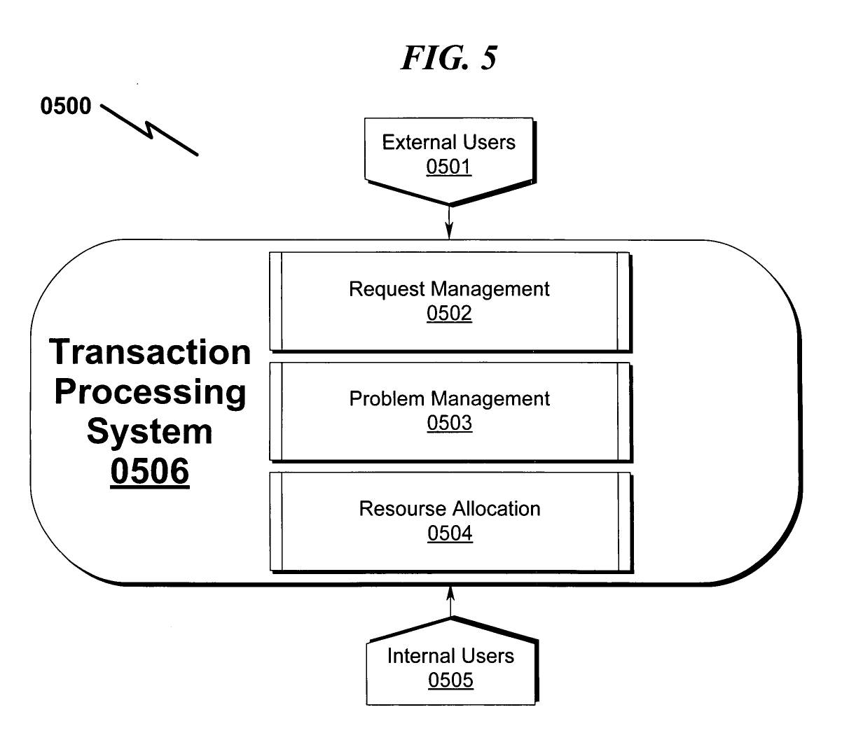

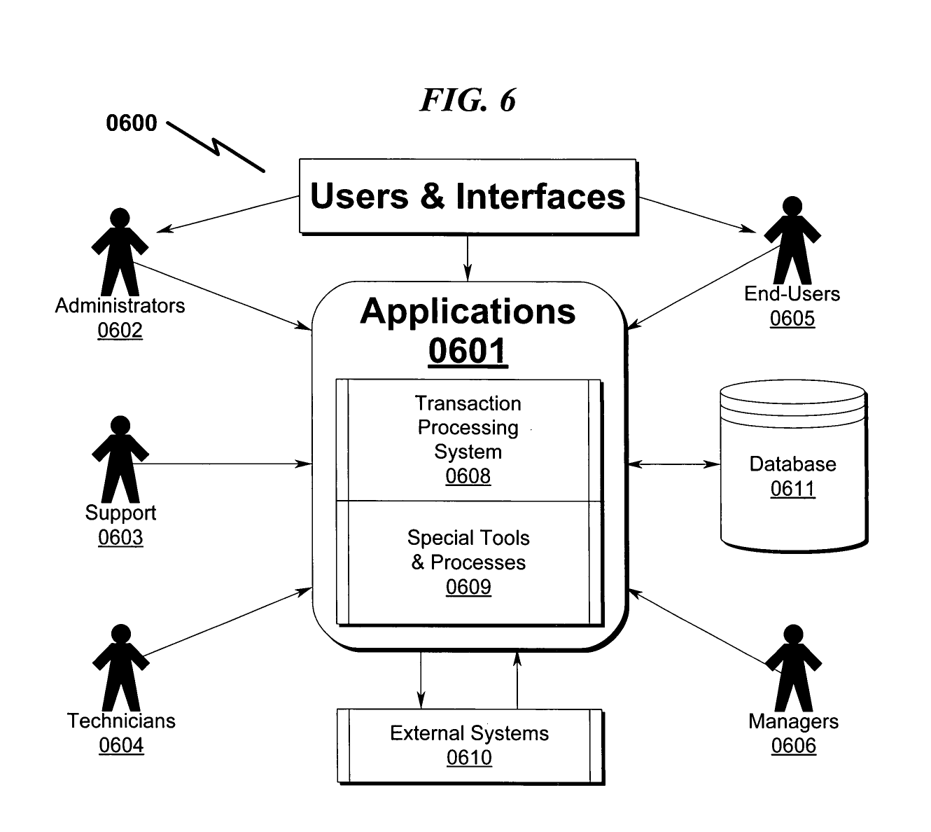

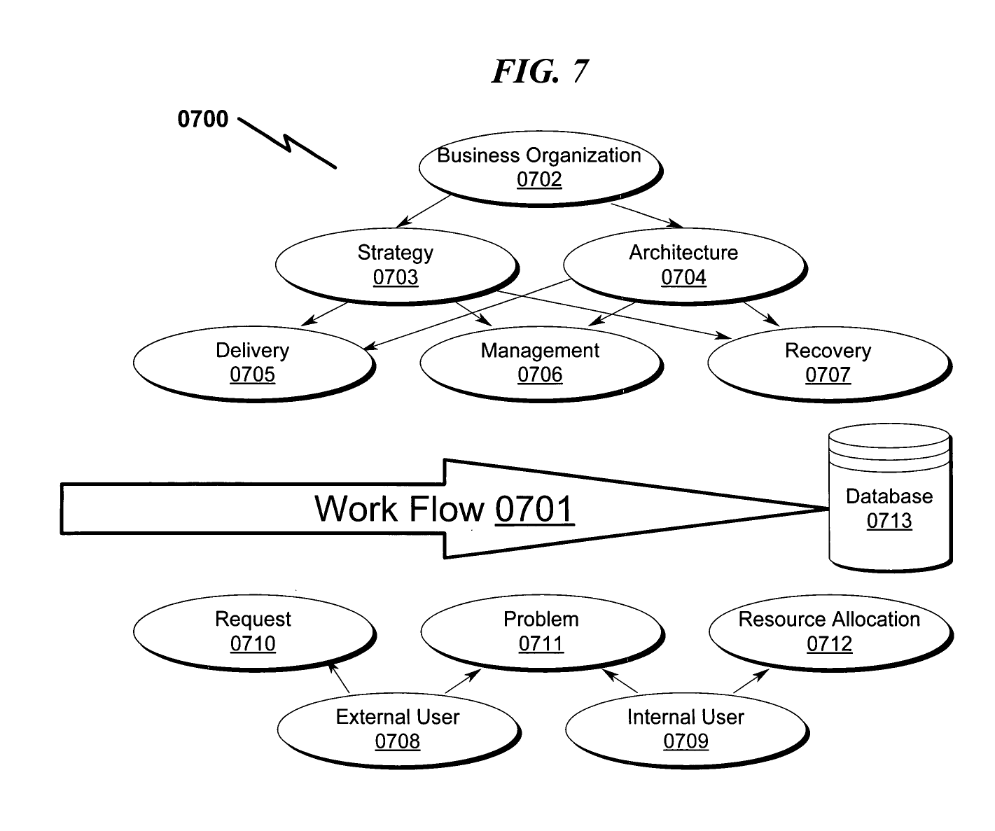

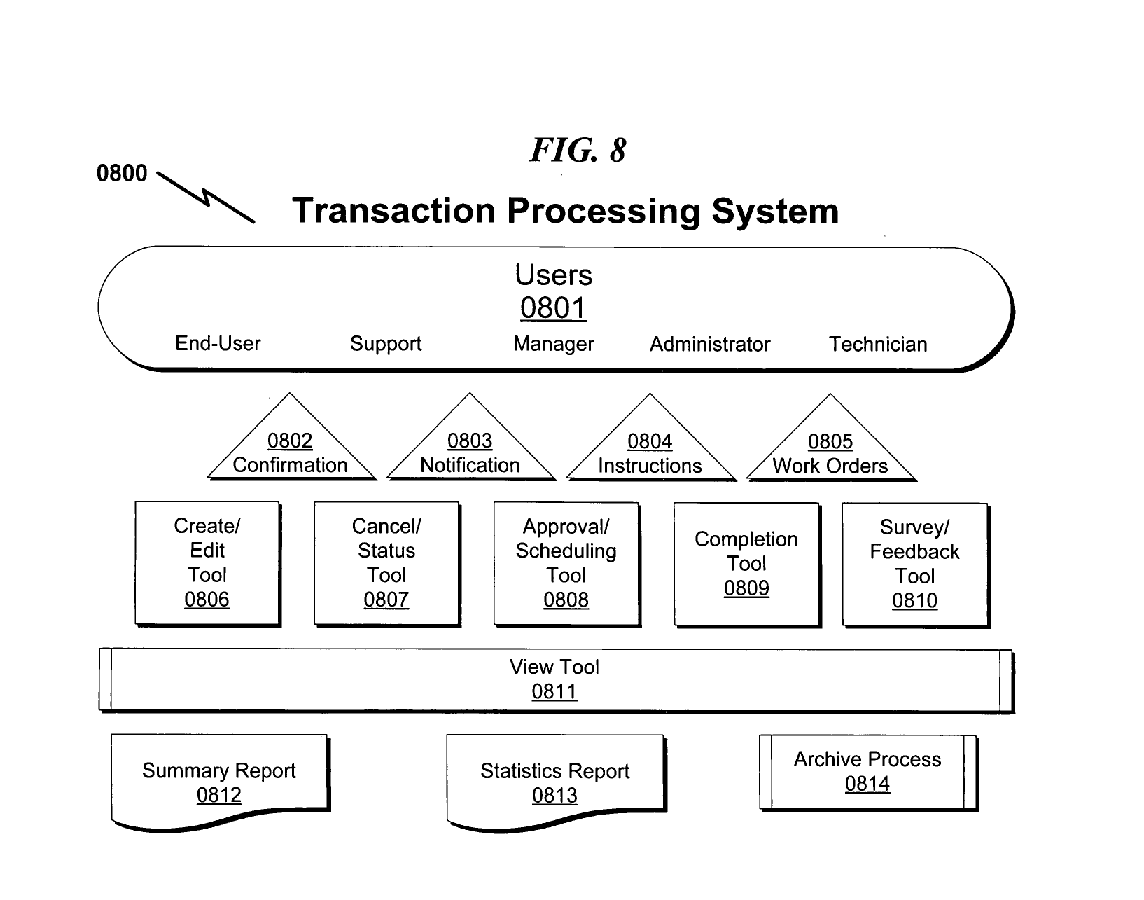

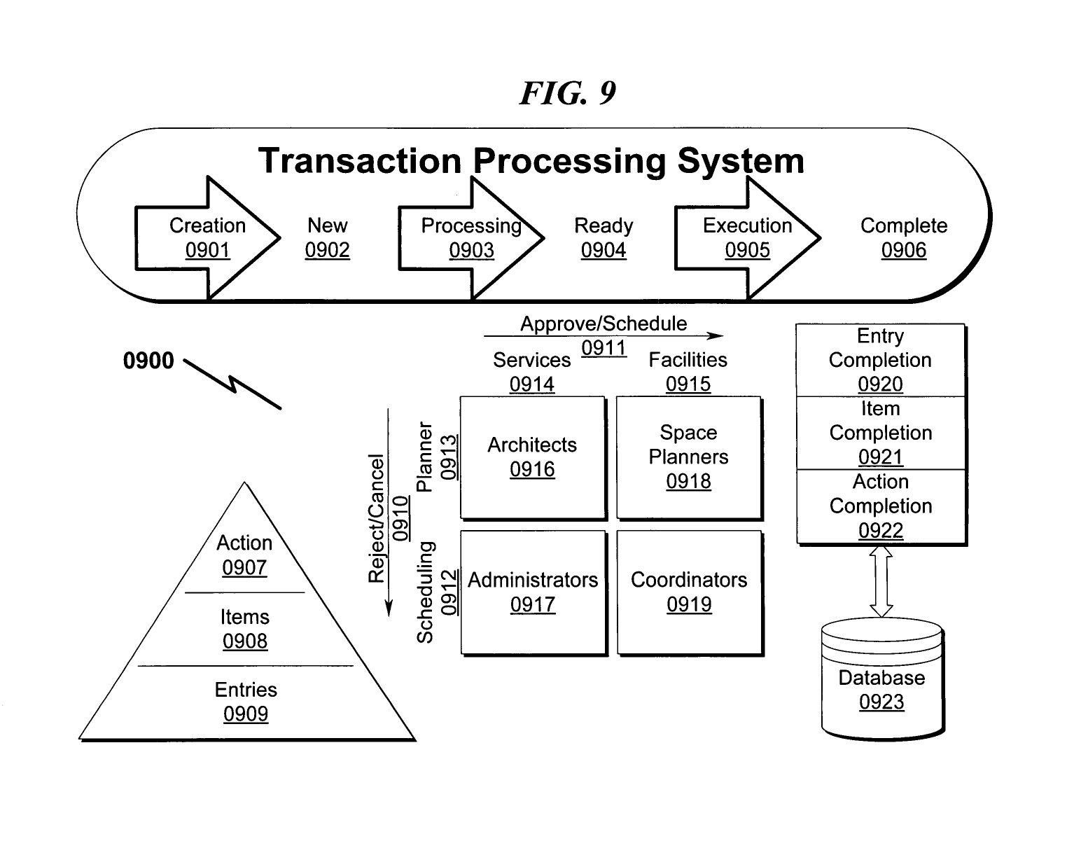

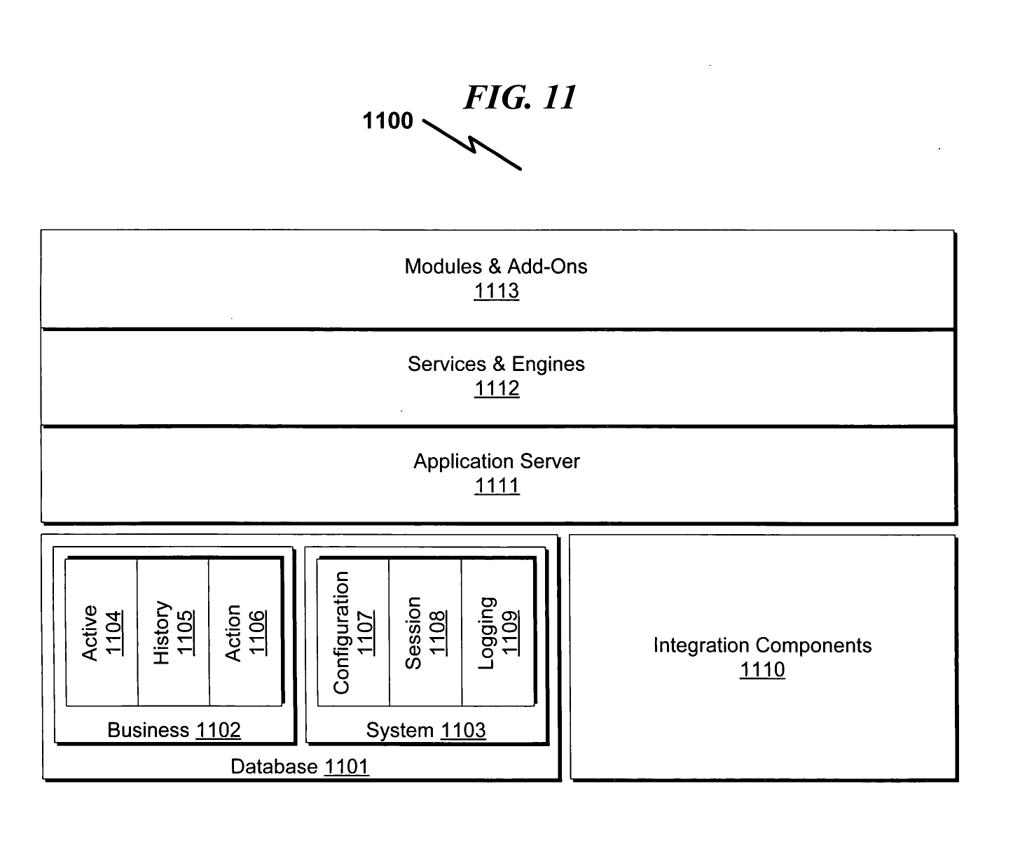

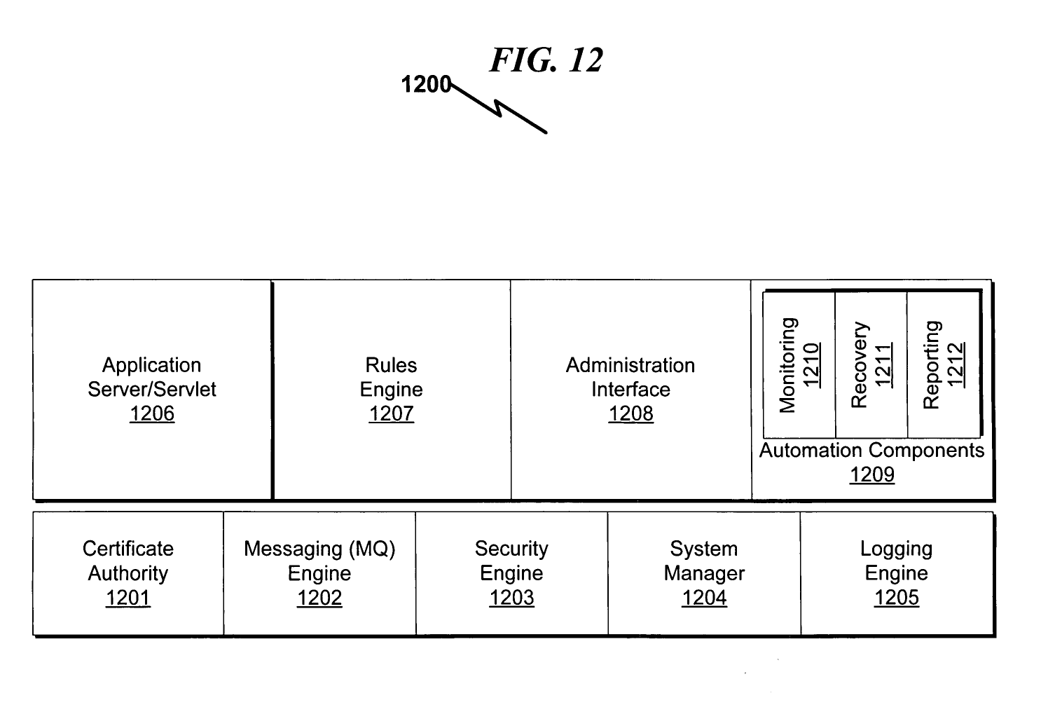

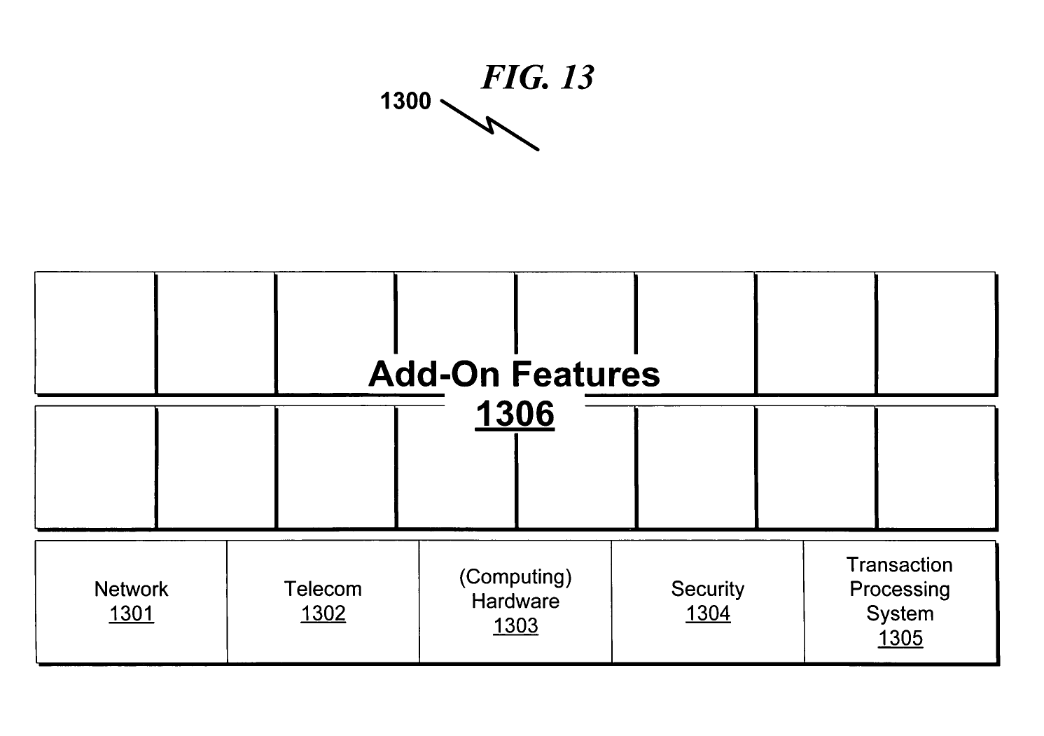

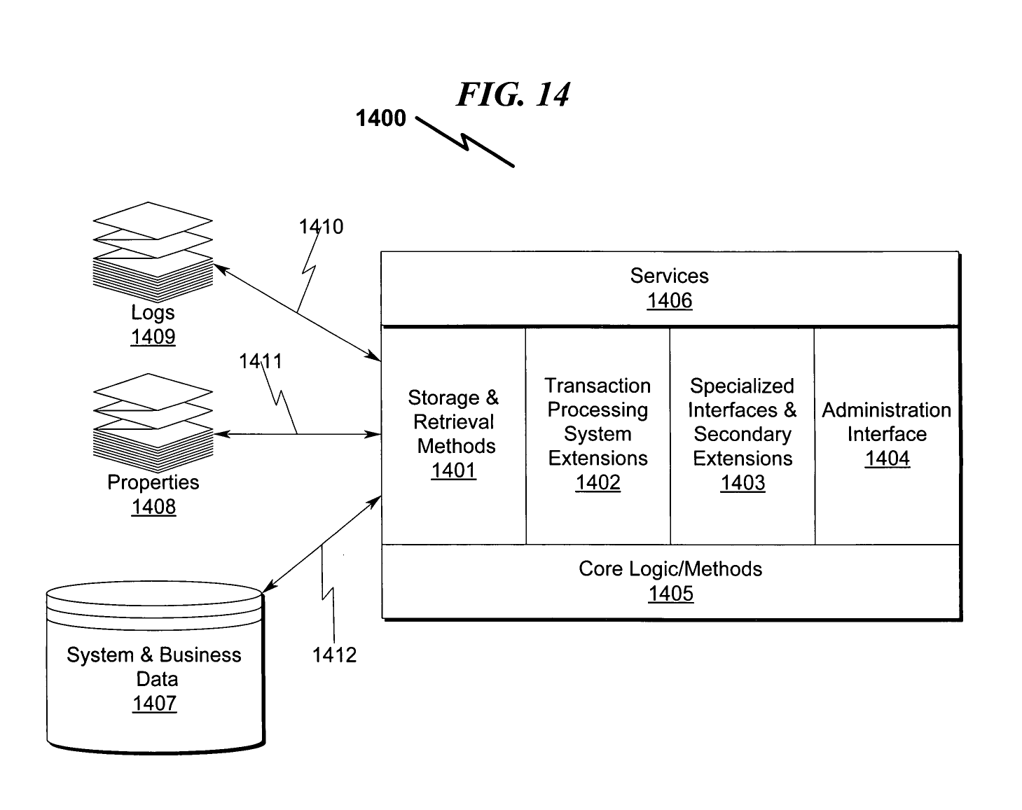

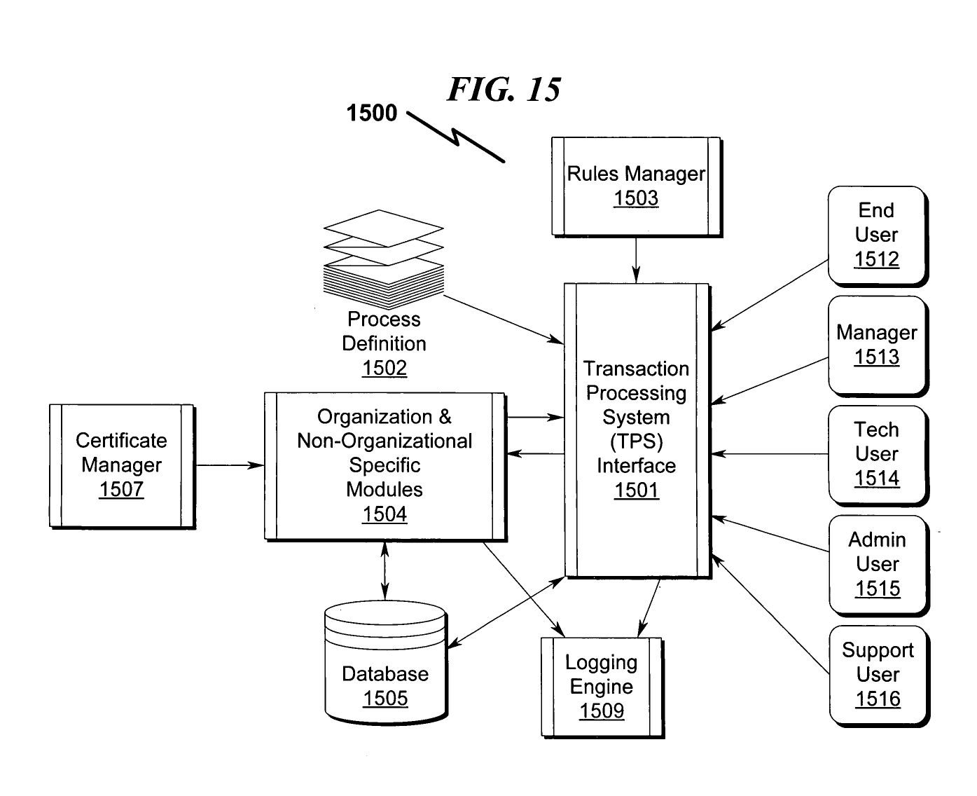

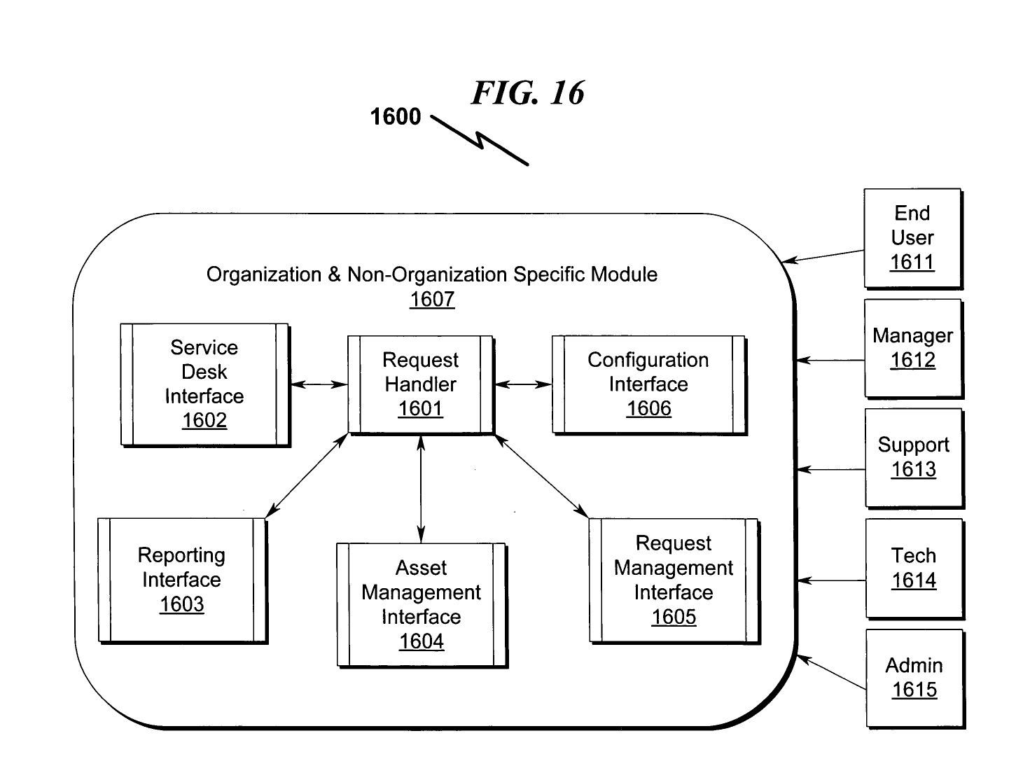

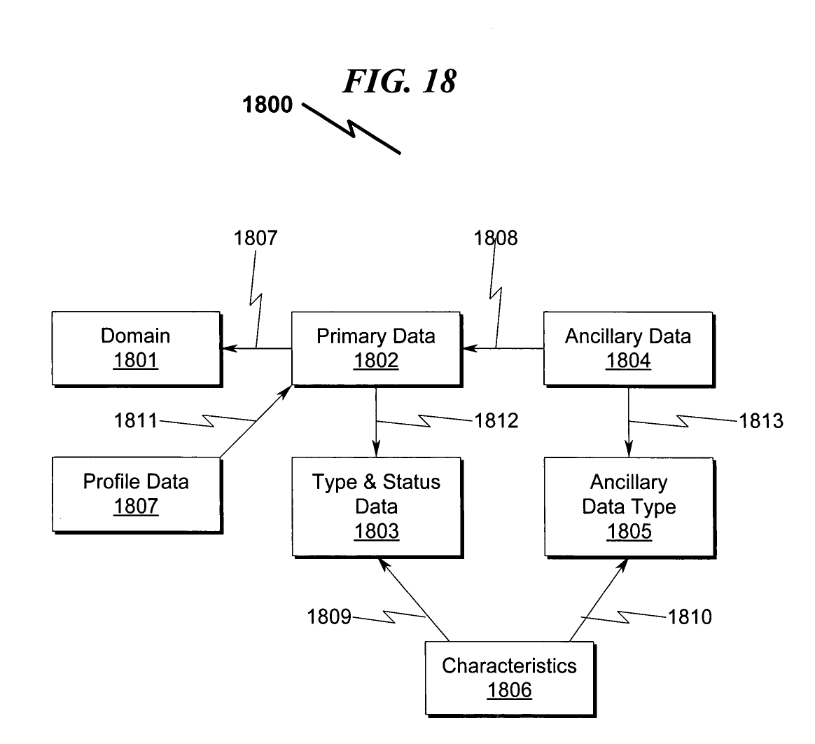

The database (0611, 0923, 1101, 1407, 1505, 3105, and detailed in FIG. 17 (1700)-FIG. 30 (3000)) is a relational database management system, comprised of a plurality of tables, views, triggers, indexes, and relationships. The data in the present invention may be generally classified as either business (1104, 1714) or system (1105, 1715) data. These database structures are described below, and illustrated in FIGS. 5 through 18.

### Business Data

Business data (1104, 1714) is the data that pertains to the business directly. The business data is divided into the following classifications: active (1104, 1702), historical (1105, 1703), and transactional (1106, 1704, 3000). These classifications are needed to segregate the information within the present invention for data integrity, storing temporal data, and providing transactional information.

### Active

Active data (1104, 1702) represents the current (temporal) configuration of the business systems. This data does not include anything pertaining to changes, other than status indicators to support pending changes.

If possible, the RDBMS should be designed to trigger off of the changes to this data and copy the data to the comparable history table (1105, 1703) automatically. Where this is not possible, the module developer may need to copy the data.

### History

Historical data (1105, 1703) is a copy of the active data (1104, 1702) prior to any change event (insert, update, or delete) along with the action, a time stamp, and trigger information (user, event or action). On inserts to an active primary (1802) or ancillary (1804) data table, the data is copied to the historical table. These changes can occur to primary or ancillary data separately, or both at the same time. Because primary and ancillary data may not both change at the same time, the history tables should not have foreign-key relationships with any other table besides the domain table (1701, 1801, 2001, 3004).

### Action

The action or transaction data (1106, 1704) represents any transaction/event that may cause a change or work to be performed that could instigate a change to the active data. Transactions can include
(1) requests to move, add or change a current configuration,
(2) problems being reported by a user, administrator, or support representative, or
(3) a request to allocate a resource.

The action (0907) is the highest level entity, including information about the domain, requester, submitter, type, and status. Each action has one or more items (0908), that includes details about the request, problem, or change. Each item can have one or more entries (0909). These entries include details about the specific activity that is needed from each organization.

As each entry activity is completed (0906, 1020), the entry's status (0920) is changed to indicate the activity has been completed. When all activities are completed, the monitoring process will change the item status to indicate the item has been completed (0921). When all items are completed, the monitoring process will change the action status to indicate the item has been completed (0922).

### System Data

The system data (1103, 1715) is used by the software applications to control and manage the computing system including configuration, sessions, and logging.

### Configuration

The configuration data (1107, 1705) includes rules, roles, and services on the computing system. Each module (1113, 1300, 1400) may have any number of tables. Thus, the configuration of the data and table design is largely free form, and at the discretion of the module designer/developer. Common data that may be housed within the database includes provisioning and profile management for groups, module rules and configurations, and logging rules.

### Session

Session data (1108, 1706) is the information obtained from the user during the discourse of using the present invention, including meta-data about the transactions, activity, configuration, etc. Typically, this is the information gathered while creating an action, and may be referenced by the TPS (0506, 0608, 0800-1000) during any views, updates, and/or other activities/events related to the transaction.

### Logging

The present invention may support logging (1109, 1707) within a database, to the application server, to the native operating system, and/or to simple flat files. The data model for the logging within the system database is free-form, and at the discretion of the module developer/designer. Reports can be pulled from most logs through standard interfaces. The decision to utilize the internal database for logging should be based on business need and module design.

### Domain

All of the business data within the present invention must be bound by a common element, the domain (1701, 1801, 2001, 3004). This common element can be utilized for a plurality of purposes, but effectively it provides a boundary around related data in all portions of the database. One of the predominant purposes for this boundary is to separate the activities/data in one geography from another, when they are co-located on the same computing system. The reason for this is because two geographically disparate sites/locations do not share the same infrastructure, and rarely share the same workers to manage the operations. Therefore, the autonomy of each site must be maintained to ensure integrity and proper normalization of the data.

In many cases, separate geographies may use similar naming, addressing, configuration, and identification that could present conflicts within the implementation. Other methods to support grouping the data in this way are by reporting periods (for billing and archival purposes) and strategic planning. Regardless of the method, the business units must all be aware of the function this domain element provides, and plan and coordinate accordingly.

More than one domain can exist within an implementation of the present invention, and the software applications/interfaces should query the user to identify the domain they require. This can present minor problems (confusion) if the present invention is not configured properly.

If multiple database systems are employed the domain data should be replicated. At a minimum the primary, ancillary, transactional, and session data must share a common domain ID.

### Schema

FIG. 17 (1700)-FIG. 30 (3000) illustrate the design, or schema, of the database used in the present invention. The schema is critical to the effective implementation of the present invention. The domain element (1701, 1801, 2001, 3104), the structure of the primary (1802), ancillary (1804), type (1803, 1805) and characteristic (1806) data/tables all help to ensure the data is consistent and accurate.

### Company and Location

The company/entity (2102) that the present invention is configured for should be defined within the database. At a minimum, the company is needed to identify the owner of the locations (2103) and the company the people (2106) report to. Also, company's can identify manufacturers/vendors of various hardware/equipment (2107) and/or external service providers. A profile (1807) may be defined for a company to support any company-wide/vendor-wide policy or requirement.

Locations (2103) are a hierarchical abstraction of physical/geographic data. Typically the highest level entity is a campus or site (2111). Within each site may be one or buildings (2112). Within each building may be one or more floors (2113) and/or rooms (2115). Because of the abstraction, the rooms can be subdivided and/or locations/features within the room (such as racks—2116) can be identified. Because of the referential constraints (2117) of the hierarchy, the higher-level entity must exist before the lower (i.e.—the building must be defined before floors can be defined that reference it). It is not necessary, however, to define floors if the building is only a single-story. Views (2110) can be created to simplify searching.

The domain element is used to establish a high-level boundary, usually based on the geography. This allows one or more sites to be documented within the same database. When the sites share the same infrastructure, however, the sites can exist within the same domain. To facilitate storage of the hierarchy of locations, the database must be structured to allow an infinite level of subdivisions (constrained by a type table) with unary relationships back to its super/parent-entity with a unique key element for identification. This unique ID does not need to be visible outside of the database, but if an acceptable identifier is available it can be utilized.

Satellite and branch offices, that do not share all of the same physical infrastructure, can share other resources and virtual infrastructure. Therefore, these sites and locations can reside within the same database, but careful planning and consideration may be necessary for effective management. One strategy is to establish a separate domain for these locations, and replicate the shared resources into each domain.

Aliases (2104) to locations can be created to support group terminology and/or secondary nomenclature. Location aliases can be for all users, or reserved for only certain groups.

Each location can have one or more portals (2105) providing access to the location. Each portal can have one or more locks or other security-controls (2109).

The location information is the foundation for the hardware (2107) and infrastructure (2108) data contained in the present invention.

In most cases, a many-to-many relationship (2121-2124) is recommended to any table that references the location and/or company data.

### People and Groups

The other foundational element of the present invention is the people/users and their groupings. Therefore, the database must include tables to store information about the people (2304) and their respective groups (2303). This data should include every occupant of the locations (2305) within the present invention. However, it must include the users referenced in the security (2306) data, at a minimum.

As with location information, every individual must have a unique identifier within the domain, and this identifier need not be visible outside of the database. Frequently companies utilize unique alpha-numeric identifiers geographically within their human resource departments. These identifiers can be utilized if consideration is given when establishing the domain boundary. It is important to realize that names are not a unique identifier in large organizations. Even relatively unique names can be duplicated, and common names may almost always be duplicated. Having duplicates would violate the referential integrity of the database, and the administrative interface(s) and integration components (0610, 1110) must ensure that integrity is maintained. Establishing information about people is also required for security, transaction/activity management, resource ownership, billing, communication and escalation. Similar to location information, people have a general hierarchy or reporting structure. Unlike locations, this may be a matrix or multi-dimensional array.

Almost all individuals belong to one or more groups. Groups (2303) are any abstract combination of one or more people (2304). The concept of group in the present invention may be used to identify roles, departments, administrators, teams, and more. However, groups are not limited to just business purposes; they may also be used to identify user types, status, designate preferences (for example, communications medium, preference, or language), and/or special security requirements or restrictions. This broad functionality allows developers of the various modules (1113, 1300, 1400) to establish groups that meet the unique requirements of the business. Module developers and designers should allow the primary administrator to choose a group for given roles. Groups can be used for any purpose.

Groups can have aliases (2304), that provide alternative naming. In deference to location aliases, group aliases are always considered to be used by any user.

Groups are self referencing (2310). They can also have any number of parent and/or child relationships. This feature provides the ability to create a dynamic mix of groupings, such as could be found in a matrix management environment.

### Infrastructure

The infrastructure (1905, 2006, 2200) data includes the data about the cabling (2202), panels (2208) (patch panels and wall plates), and the ports (2204) on those panels. The present invention is designed to support any cabling scheme, but may work best with a structured cable plant.

A cable (2202) is a hierarchical abstraction of an actual cable. Thus, the present invention may track the information about a cable down to it's individual strands. The database also stores the information about the “other end” (2205) and the parent (2210) cable. Additionally, the database design supports any cable type. Cables must be unique within the location (2207) they are located in.

Panels (2208) are an abstraction for any two-sided device with one or more ports (2204) that a cable (2202) can be connected to. The panel data may be used for both patch panels and wall plates, as well as any other intermediate cable connection point. Panels must be unique within the location (2207) they are located in.

The ports (2204) on the “panels” (2208) are the individual ports that the cables connect to. Ports have one or more faces (usually two), and can have a cable connection on each face. Ports must be unique on the panel (2208) they belong. Ports can be connected (2214) to hardware interfaces (2206).

### Hardware

Hardware (1909, 2011, 2900), as defined by the present invention is an abstraction of any piece of equipment—furniture, computing, network, telecommunications, etc. While some services (2908) and equipment, such as network (2906) and telecom (2907), are managed by separate groups, the interfaces (2903) and ties to the infrastructure (2911) are usually shared. With the convergence of IP and voice, this paradigm will only become more common. Therefore, the physical hardware, including location (2910), is tracked separately from the business service (2908) it provides.

Each of these devices can have one or more interfaces (2903). These interfaces are related to their respective infrastructure (2911) port. Each interface can also have a OSI layer-2 (hardware) address such a media access control (MAC), Ethernet Hardware Address (EHA), or other network (2906) hardware address. Optionally, the interface can have one or more OSI layer-3 addresses (2912) assigned to it.

Each device also supports having one or more user accounts (2904), that are related to the person (2905) that is responsible for it. Most accounts will have some form of security (2909) associated with it.

The present invention supports abstracting hardware to include tracking the location (2910) and other data about any type of furniture item(s) including desks, cabinets, chairs, asset tracking and more. These can have one or more locks or other physical access controls, that are tracked in the security tables (2909).

Using this hardware abstraction, the present invention may support tracking all hard assets/components, and their respective connectivity to the infrastructure.

### Services

A “service” (1910, 2012, 2700) is any network feature or interface that can be remotely accessed or queried. The present invention provides mechanisms to manage numerous services such as databases, messaging systems, application/web servers, email, and many more. A service is usually associated with the hardware (2703) it is provided/hosted on. Services may also utilize some form of security (2704), including password and certificate-based authentication.

### Networking and Addressing

The network information (1912, 2002, 2500, 2600) stored in the database includes the network devices (2502), physical layers (2503), logical layers (virtual networks and segments) (2504), OSI layer-2 (hardware) addressing (2505), domain (2601) and host name (2605) allocation, zoning and subnetting (2602, 2603), and OSI layer-3 (node) addressing (2604). The present invention includes support for forward and reverse resolution (lookup) of addresses (2604) and dynamic OSI layer-3 addressing for automated host configuration (2608).

A network device (2502) is a hierarchical (2508) abstraction for the device. A device can contain one or more sub-devices, and so on. Network devices are also considered hardware (2506), and are referred to by their hardware ID. The hardware group stores the information about the physical device, such as manufacturer serial number, physical location, and interfaces. These interfaces are associated to their physical port ID, and mapped to their OSI layer-2 hardware address (2505).

The network devices (2502) exist in one or more physical networks (2503). A network, in this sense, is an abstraction for the physical layers of any computer networking system (OSI layer 1). The present invention correlates these networks to their respective INET ARPA zones (2602).

Each network (2503) can be broken down into segments (2504), and each segment can be associated with one or more OSI layer-3 sub-networks (2603). Each segment can have any number of OSI layer-2 hardware addresses (2505), and the correlation between the physical ports (hardware interfaces—2506) and/or OSI layer-3 addressing can be extracted from the network devices via manual processes and automated queries.

The present invention includes data, methods and processes to store and manage all aspects of OSI layer-3 addressing, including information about every individual address (2604), host names (2605), and domain names (2601) used by the company. Thus, the present invention provides the ability to provide forward and reverse address resolution (2607), and dynamic automated OSI layer-3 configuration (2608) information. Additional address-related records can be stored in special tables (2606) that provide the ability for the present invention to function as a complete server. These servers are also managed by the hardware (2609) tables.

### Voice and VoIP

The present invention supports storing and managing information about telecommunications systems (1911, 2013, 2800) such as private branch exchanges (PBX) and newer convergent technologies such as voice over IP (VoIP). The data includes information about the switch and other devices (2802), services (2805), prefix (2803) and extensions (2804), and lines (2806).

Telecom devices (2802) includes switches and other equipment. These devices are also tracked as hardware (2807) tied to the infrastructure. Each device defines or uses a plurality of services (2805) and/or extensions (2804).

Extensions (2804) are tied to a prefix (2803). Each prefix can be configured to support a different numbering scheme as needed by locale.

The combination of an extension (2804) with certain services (2805) create a line (2806). This combination of tying the service (and the related functionality) with the features and ancillary data associated with the extension will ensure the present invention may support most telecommunication systems.

Newer services (2805) provide a mechanism to transmit voice data over networks. Support for these advances in technology can be supported by creating special tables such as for Voice over IP (VoIP), that results in associating an IPv4/6 address (2809) with the voice service.

### Security

The present invention provides mechanisms to track and manage information about security (1908, 2010, 2400) for hardware (2411), services (2427), locks (2406) and keys (2402) for location (2410) portals (doors) and furniture (2409), badges (2403), certificates (2404), and passwords (2405). Keys and badges are owned by people (2407), certificates (2404) and passwords (2405) can be owned/associated with people (2407) or groups (2408). Certificates (2404) and passwords (2405) can be associated with hardware (2411) and services (2427).

### Application Design

The software applications are designed to utilize the data stored in the database (0611, 0923, 1101, 1407, 1505, 3105, and detailed in FIG. 17 (1700)-FIG. 30 (3000)) to provide the optimal interface (0608-0609) for the user (0602-0606) it is intended. Module designers/developers should consider the unique needs of each class/group of users, and develop interfaces/components (1402-1404, 1601-1606) to meet those needs.

Again, the present invention may be embodied in numerous ways, but the current preferred method is to utilize an application server (1111, 1206). The components on the application server can be divided into a number of groups including services and engines (1112, 1200), modules and add-ons (1113, 1300, 1400, 1504, 1607, 3104), and integration components (0610, 1110).

These components work together in concert to create an extensible framework. Most components provide only discrete services and/or interfaces that are then implemented within others. Utilizing this framework, a combination of components can be built to support the infrastructure operations of almost any company/organization.

### Services and Engines

The services and engines (1112, 1200) are the core software components of the present invention. These components provide a framework for a myriad of additional (non-core) modular components (1113, 1300, 1400). Module developers may access these services and interfaces through direct application programming interface (API) calls, indirect or remote method invocations (RMI, IIOP, RPC), web-services, and/or message-based queues.

### System Manager (SM)

The system manager (1204) is the first module loaded by the application server. This code loads/starts all of the other core components and modules as configured by the properties/configuration file and system database. The system manager then continues to monitor the processes, stop errant processes, restart essential modules, and report problems to primary administrators.

### Security Engine (SE)

The security engine (1203) provides a central mechanism for authenticating users, and validating the roles/access for sessions, users, modules and messages by utilizing a combination of rules and certificates. Module developers may use the security engine primarily to validate a user. When the security engine is given a certificate, it will validate the certificate with the CA (1201). When the user attempts to log in using a password-based authentication, the security engine may attempt to validate the password using the mechanism indicated.

This ability can be extended both internally and externally of the present invention. Therefore, the security interface can also be exposed as a service such as RADIUS, TACACS, or LDAP-based authentication. This can then be used to control access to various network and computing environments—providing centralized password management for hardware and services.

The security engine should also provide controls for password length, complexity, renewal, and failure events. These controls should be configurable through company, location, group and service profiles, and stored in the description and control language.

### Certificate Authority (CA)

Basic security is provided within the present invention using industry standard digital certificates. When the application server starts the system manager (1204), the first components the SM attempts to start are the messaging engine (1202) and certificate authority (1201). The certificate authority component may then attempt to certify itself with an external certificate authority. Once validated, the system manager begins loading the remaining modules. Each module is required to present a certificate to the system manager when started. The system manager sends the certificate to the certificate authority for validation. If the certificate authority approves the certificate, the module is started. If it can not validate the certificate, the certificate is forwarded to the master CA that validated the local certificate. If the master CA approves the certificate, the certificate information is stored locally and the module is loaded. If the master CA does not approve the certificate, the module is rejected, notifications are dispatched, the system manager stops the errant process/thread and moves to the next module.

The certificate authority (CA) is the heart of the security mechanisms used in the present invention. It is recommended, but not necessary, to use an industry standard such as X.500. Using an industry standard, however, may allow the present invention to support encrypting all communications using these certificates. Even inter-process communication via messaging system should utilize an encryption technology, and a certificate based technology such as X.509

This security model is required by the present invention to ensure adequate security compliance required by many companies, institutions and government agencies.

### Rules Engine (RE)

The rules engine (1207, 1503) is the interpreter for the description and control language. The rules engine can also generate description and control information and store it in a profile or configuration table. This engine should work in concert with the security engine to control which features/services a user can access, and that processes require special approval and intervention. The rules engine should read the configuration and profile(s) to determine the requirements for approving a request. Module developers may need to identify the mechanism(s) required to provide approval, and what to do in the event of a success or failure.

### Messaging Engine (ME)

The messaging engine (1202) implements the queue manager and various messaging queues. While no standards exist, yet, for a messaging system, there are many readily available implementations that can be incorporated. The key features that are needed are persistence and network support.

Persistence refers to the message queuing systems ability to store information/data as it is being transferred through the queue. In the event of a computing or network failure, the data is stored locally and retransmitted when the problem is resolved.

Network support means the messaging system is able to transfer messages across any data and/or telecommunications network. This may facilitate the present invention operating on a multi-tiered environment, as well as, it can facilitate communication to/from external computing systems.

### Logging Engine (LE)

The logging engine (1205) provides the facilities to store information about events that occur. These logs can either be stored within a relational database or externally in a flat file or operating system logs. The logging engine should read the profile and/or configuration information to determine the content and method for storing the logs.

### Web Portal (WP)

The application server or servlet (1206) provides the mechanisms for the various modules to expose their web-based interfaces. Modules and add-ons may be designed to function within any framework including providing web applications, servlets, portlets, standard web interfaces, applets, and web-based services.

The web portal engine should follow the industry standard for web interfaces. This will ensure compatibility with other computing platforms and ease development by utilizing well-documented standards.

### Administration Interface (AI)

The administration interface (1208) is a web-based interface used to configure the basic configuration of the core components. This service is accessible via a separate port from the web portal, and does not require the web portal to function. This may allow the web portal to be configured independently or even to be shut down completely.

### Automation Components (AC)

The automation components (1209) are special components running under the system manager (1204). These components provide mechanisms to monitor, recover and report. The rules for these components may be stored in the description and control in configuration tables and/or properties files.

Automation is provided through a series of engines that are programmed using description and control to look for issues or any other activity based on programmable criteria, report findings, and automatically recover when possible. Using a specialized language, discussed later, module designers and users can construct complex processes that execute continually or on any schedule. Dividing these functions into separate components helps to eliminate contention and ensures the computing system can continue monitoring even when other issues have occurred.

### Monitoring (AC-M)

The monitoring engine (1210) is a process that runs continually, and looks for events or situations to execute some code, process, log, etc. When found, the code can perform any combination of simple and/or complex tasks. The intention of this engine is to look for any situation that requires triggering another action such as reporting and/or recovery. The focus of this engine (and the processes it calls) is on spotting activity/situations that require some action. In many cases it may call the recovery and/or reporting engine(s) as needed/defined in the description and control language. The primary triggers for the monitoring engine are messages on a queues, polling, and/or time-based events (scheduling).

The monitoring engine may provide mechanisms to access, control, and query processes. This engine may be used to detect problems within the process flow and initiate automated events.

### Recovery (AC-R)

The recovery engine (1211) also runs continually, and accepts remote calls to initiate an action such as restarting processes, altering messages in a queue, updating data in the database, initiating new processes later monitoring/execution. The primary focus of this engine is to take some action to ameliorate and/or escalate a problem. Ultimately, if no solution is possible, it may ensure the appropriate information is communicated to primary administrators. As above, the recovery engine can be used for any range of critical and/or mundane tasks.

The recovery engine may provide mechanisms to support remediation, escalation, and cost/resource recovery.

### Reporting (AC-P)

The reporting engine (1212) is another process that runs continually, and accepts remote calls to initiate logging, generate email, fax, page, print, invoke other alert mechanisms, and/or initiate other remote calls. The focus of this module is to communicate. This engine is not only for emergencies and problem remediation. It can also be called for mundane tasks such as generating work orders for technicians, or emailing updates and notifications to various users.

The reporting engine may provide reporting mechanisms including status, problems, changes, billing and other communication-related events based on defined rules.

### Modules and Add-Ons

One purpose of the present invention is to support a myriad of operations-level functions and technologies. To achieve this, the present invention is designed to be modular. These modules and add-ons (1113, 1300, 1400, 1504, 1607 & 3104) are designed to perform multiple functions using the framework exposed by the core engines and services (1112, 1200), for multiple users.

Each module provides a combination of interfaces, methods and services (1401-1406, 1601-1606). At a minimum, each module will need to include an administration or configuration interface (1404, 1606) to configure the module. This interface may need to include mechanisms to define the users (groups or individuals), processes, services and configuration. If no group is assigned as an administration group or the group(s) is/are empty, the administration interface may be accessible by all users.

Most modules may include interfaces for end-users by providing information by providing extensions to the transaction processing system (0506, 0608, 0800-1000). The module can define any number of buttons, panels, and portlets to be displayed. Work flows may be created using the description and control language (1502, 3102) that will describe/control the order and features the TPS uses.

Specialized interfaces and secondary extensions (0609, 1403) should be created to handle special situations, particular users, and/or business needs. These can also implement free-standing tools such as applets.

The modules should also provide services (0403) to generate reports, control processes, and provide for communications with other applications and modules.

Special methods (1401) should be defined to handle communicating with the database (0611, 0923, 1101, 1407, 1505, 3105, and detailed in FIG. 17 (1700)-FIG. 30 (3000)), properties (1408), and logs (1409).

Given the flexibility of description and control language (1502, 3102) and the present invention design, groups can be defined to separate the administration of the various functions within a module. The definition names should generally not be hard-coded. Instead, these parameters should optimally be stored in configuration tables (1107, 1705) and/or properties (1408) files.

This list does not include all of the possible modules and/or features within each module. It is only a representative basis for the majority of common features. New technology and business requirements may dictate additions, changes, and removal of certain features. This should be considered by the module designer.

Modules can loosely be described as being specific to one organization or business area within the enterprise, or non-organization specific. Non-organization specific modules provide common interfaces that can be used by other modules.

### Non-Organization Specific Modules

Some of the common non-organization specific modules are people, groups, infrastructure, location, company, hardware, services, and security.

### People Management

This module must have mechanisms to manage the people in the database, and expose services to search for people in the database. This module should also be designed to allow updates (manual or automated) from external systems/subsystems through any form of interface, service or process.

### Group Management

This module must have mechanisms to manage groups of people in the database, and expose services to search for groups in the database by ownership, members, roles, and relationship with resources. This module should also be designed to allow updates (manual or automated) from external systems/subsystems through any form of interface, service or process.

### Infrastructure Management

The infrastructure management module may provide the necessary features to support managing the facility (floor plan), cabling infrastructure, space utilization, and other functions and services related to the physical facility.

This module should also provide search mechanisms for other modules to query information about the facility, physical security, and cable plant.

### Security

The security module provides physical security to the facility through badges and key management, as well as user account management on any hardware.

### Hardware Management

This module provides tools to manage hardware such as network and telecom devices, computing equipment such as desktops, laptops and server, and similar equipment that can be configured. Many of these devices have one or more interfaces that connect the device to the infrastructure.

### Service Management

Services are provided by applications running on computing systems that support some method of remote invocation or access. These services typically require special administration, but can include common services provided by the operating system. This module should provide interfaces for users to add, change, and remove services from appropriate hardware.

### Organization-Specific Modules

Organization-specific modules focus on the needs of individual business areas such as networking, telecommunications, facilities, furniture, and more.

### Network Services

The network services module provides interfaces and services to manage most network technologies. The module should provide tooling/interfaces for managing equipment/devices, physical and logical configurations, segmenting and sub-networking, OSI layer-2 (hardware) and layer-3 addressing schemes and services.

### Telecommunications

The telecommunications module provides interfaces and services to manage telecommunications equipment, services and phone lines.

### Furniture

The furniture module provides mechanisms to add, change, and remove furniture data. Interfaces should be provided for the TPS, queries, and bulk loads of information.

### Transaction Processing System

This specialized module is the primary interface for most of the daily operations. Other modules may utilize this framework to provide interfaces for users to submit problems, requests and allocations. Technicians, administrators, support personnel and managers may also have specialized tools to process, schedule, track and report actions within the business.

When transactions are created, they are set to the new state, and may have some indication of priority or severity. The priority helps determine ordering, and may be used to expedite a transaction. As the transaction is processed, it may be sent to different queues depending on the configuration indicated by the description and control language (1502, 3102). Once the transaction has received all approvals and scheduling, it is set to the ready state. Technicians and administrators may use the completion tool to close each item in the transaction. When the last item is completed, the completion tool will attempt to set the state of the transaction to complete.

### Reporting Module

This component may provide mechanisms to generate any combination of pre-packaged (canned) or ad-hoc reporting. The module may utilize interfaces provided by other modules, and give the user the ability to drill down and locate information, provided they have proper authorization. This reporting module can also create scheduled events to generate and send reports to an individual or group.

Each module may also provide reporting services, that the reporting module can aggregate and correlate with data from other modules and systems.

### Integration Components

Integration components (0610, 1110) are a loosely grouped set of tools that provide mechanisms to push and/or pull data to/from legacy and proprietary systems, as well as, various non-specific data feeds. These tools may generally be developed by the engagement team when implementing the present invention at a specific customer location. These tools generally do not utilize the framework, except when an interface is provided and special steps are taken to manage security. Most of these components may simply communicate directly with the database, and provide any combination of change, read, update and/or deletes.

### System Abstraction (3400)

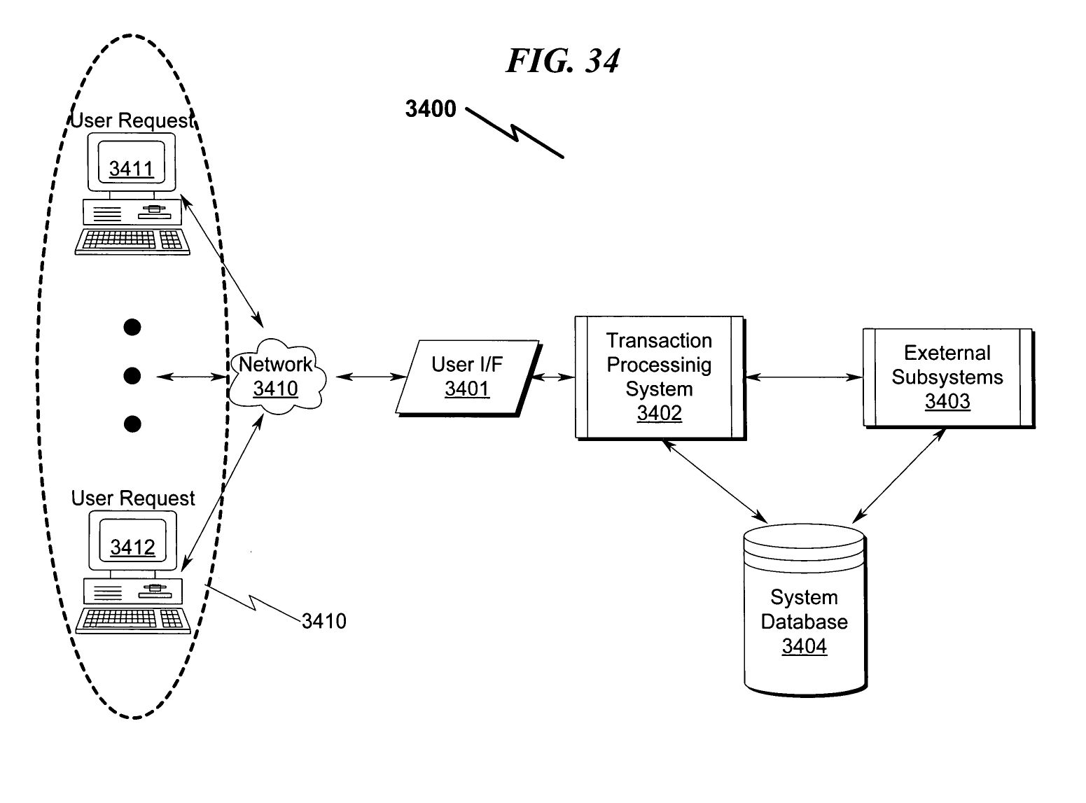

At its most general level, the present invention system can be illustrated schematically as shown in FIG. 34 (3400), wherein the infrastructure operations management system comprises:
(a) user interface (3401);
(b) transaction processing system (3402) further comprising request management, problem management, and resource allocation subsystems;
(c) external subsystems (3403); and
(d) system database (3404);
   wherein
   the user interface employs a computer network (3410) to integrate user requests (3411, 3412) among an enterprise (3410) under control of a computer system;
   the user interface communicates between a computer system implementing the transaction processing system and an end user, manager, administrator, support personnel, or technician within the enterprise;
   the transaction processing system queues tasks for requests, problems, or resource allocations to the external subsystems;
   the tasks are processed and controlled via a process and control language definition;
   the transaction processing system coordinates the task deployment, status of the task deployment, and results of the task deployment via the system database; and
   the transaction processing system permits localized control and integration of the tasks among infrastructure and information technology services within the enterprise.

### Specific Variations

The above generalized system may be varied in a number of ways but some specifically anticipated variations include the following:
The transaction processing system in this abstraction may be implemented by one or more methods, an exemplary example of which is generally illustrated in the flowchart of FIG. 33 (3300).
The system database may incorporate information on IT services, capacity planning, facilities, personnel, infrastructure management, and space planning for the enterprise.
The transaction processing system further comprises confirmation, notification, instruction, and work order processing subsystems.
The transaction processing system further comprises tools available via the user interface to permit creation of tasks, editing of tasks, task cancellation, task status marking, task approval, task scheduling, task completion, and task survey/feedback, and task status viewing.
The transaction processing system further comprises tools available via the user interface to permit creation of summary and statistics reports.
The transaction processing system further comprises tools available via the user interface to permit archiving of configurations and processes for the enterprise.
The transaction processing system further comprises tools available via the user interface that are specific to particular types of users, including end-users, management, technicians, administrators, and support users.
The system database contains data that is organized by enterprise domain.
A business process description and control language is utilized to support flexibility, configuration, and/or modeling of processes within the transaction processing system.

One skilled in the art will recognize that the abstracted system invention illustrated in FIG. 34 (3400) may be augmented or varied in numerous other ways detailed in this document without departing from the spirit of the invention, and that the above list of variations is only exemplary.

### System Variations

The present invention anticipates a wide variety of variations in the basic theme of construction. The examples presented previously do not represent the entire scope of possible usages. They are meant to cite a few of the almost limitless possibilities.

Furthermore, embodiments of various methods associated with the invention (including but not limited to the transaction processing system) may be integrated within a variety of components comprising system embodiments of the present invention.

While the system as described may be implemented on a wide variety of computer systems, many preferred embodiments utilize some variant of MICROSOFT® WINDOWS® O/S.

### Method Abstraction (3500)

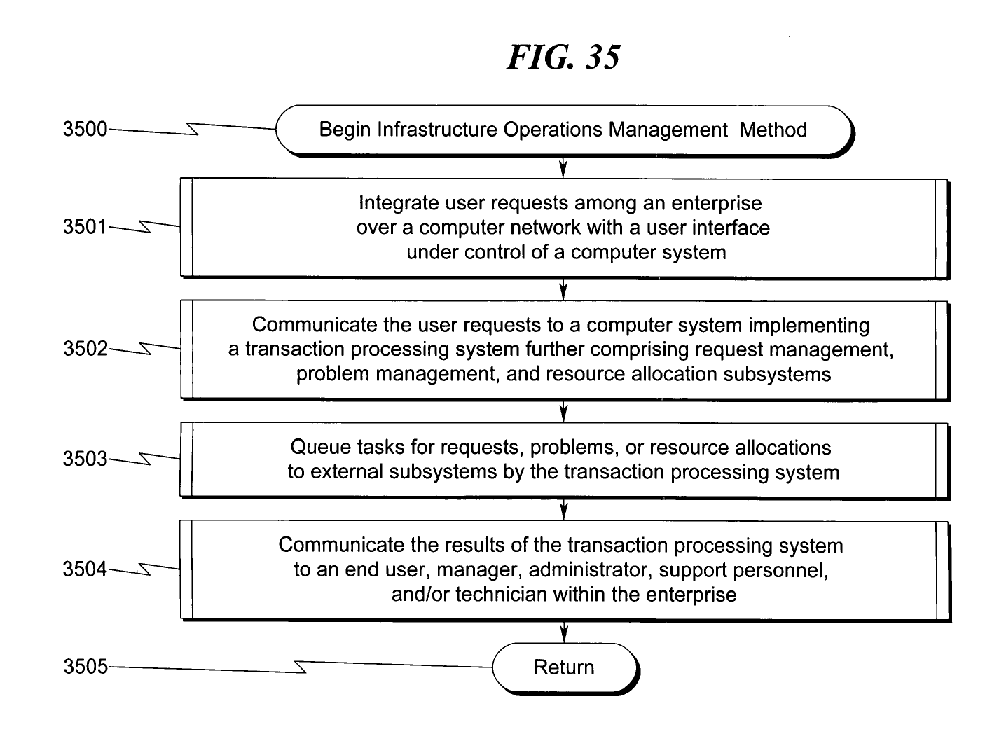

At its most general level, the present invention method can be illustrated in the flowchart as shown in FIG. 35 (3500), wherein the infrastructure operations management method comprises the steps of:
(a) integrating user requests among an enterprise over a computer network with a user interface under control of a computer system (3501);
(b) communicating the user requests to a computer system implementing a transaction processing system further comprising request management, problem management, and resource allocation subsystems (3502);
(c) queuing tasks for requests, problems, or resource allocations to external subsystems by the transaction processing system (3503); and
(d) communicating the results of the transaction processing system to an end user, manager, administrator, support personnel, and/or technician within the enterprise (3504);
   wherein
   the tasks are processed and controlled via a process and control language definition;
   the transaction processing system coordinates the task deployment, status of the task deployment, and results of the task deployment via a system database; and
   the transaction processing system permits localized control and integration of the tasks among infrastructure and information technology services within the enterprise.

### Specific Variations

The above generalized method may be varied in a number of ways but some specifically anticipated variations include the following:
The transaction processing system in this abstraction may be implemented by one or more methods, an exemplary example of which is generally illustrated in the flowchart of FIG. 33 (3300).
The system database incorporates information on IT services, capacity planning, facilities, personnel, infrastructure management, and space planning for the enterprise.
The transaction processing system further comprises confirmation, notification, instruction, and work order processing subsystems.
The transaction processing system further comprises tools available via the user interface to permit creation of tasks, editing of tasks, task cancellation, task status marking, task approval, task scheduling, task completion, and task survey/feedback, and task status viewing.
The transaction processing system further comprises tools available via the user interface to permit creation of summary and statistics reports.
The transaction processing system further comprises tools available via the user interface to permit archiving of configurations and processes for the enterprise.
The transaction processing system further comprises tools available via the user interface that are specific to particular types of users, including end-users, management, technicians, administrators, and support users.
The system database contains data that is organized by enterprise domain.
A business process description and control language is utilized to support flexibility, configuration, and/or modeling of processes within the transaction processing system.

One skilled in the art will recognize that the abstracted method invention illustrated in FIG. 35 (3500) may be augmented or varied in numerous other ways detailed in this document without departing from the spirit of the invention, and that the above list of variations is only exemplary.

### Method Variations

The present method invention anticipates a wide variety of variations in the basic theme of implementation. The examples presented previously do not represent the entire scope of possible usages. They are meant to cite a few of the almost limitless possibilities.

Furthermore, embodiments of various methods associated with the invention (including but not limited to the transaction processing system) may be integrated within a variety of components comprising system embodiments of the present invention.

While the method as described may be implemented on a wide variety of computer systems, many preferred embodiments utilize some variant of MICROSOFT® WINDOWS® O/S.

### CONCLUSION

A business computing system and method for integrated management of operations and infrastructure of a business has been disclosed. The system architecture contains data stored in one or more relational databases, web-based, and/or non-web based user interfaces provided by an aggregation of software, automated processes, and a transaction processing system. A standardized interface is defined for modular components to be incorporated. A specialized business process description and control language is utilized to support flexibility, configuration, and modeling of processes. Persistent messaging is utilized for inter-process communication. Various other processes and components provide automation and integration with external systems/subsystems. The purpose of this combination of applications and business processes is to provide a robust and flexible enterprise management platform for managing infrastructure (including facilities, cabling, security, furniture, etc.) and information technology (IT) services (including network, voice, platform management, printing, etc.).

Although a preferred embodiment of the present invention has been illustrated in the accompanying drawings and described in the foregoing Detailed Description, it will be understood that the present invention is not limited to the embodiments disclosed, but is capable of numerous rearrangements, modifications, and substitutions without departing from the spirit of the present invention as set forth and defined by the following claims.

What is claimed is:

1. An infrastructure operations management system comprising:
(a) user interface;
(b) transaction processing system further comprising request management, problem management, and resource allocation subsystems;
(c) external subsystems; and
(d) system database;
wherein
said user interface employs a computer network to integrate user requests among an enterprise under control of a computer system;
said user interface communicates between a computer system implementing said transaction processing system and an end user, manager, administrator, support personnel, or technician within said enterprise;
said transaction processing system queues tasks for requests, problems, or resource allocations to said external subsystems;
said tasks are processed and controlled via a process and control language definition;
said transaction processing system coordinates said task deployment, status of said task deployment, and results of said task deployment via said system database; and
said transaction processing system permits localized control and integration of said tasks among infrastructure and information technology services within said enterprise.

2. The infrastructure operations management system of claim 1 wherein said transaction processing system further comprises software implementing the steps of:
(1) Accepting a transaction submitted by a user and sending appropriate notifications;
(2) Classifying said transaction as a problem, request, and/or change;
(3) If said transaction is a problem, proceeding to step (6);
(4) If said transaction is a request, proceeding to step (7);
(5) If said transaction is a change, proceeding to step (8);
(6) Processing said transaction severity and proceeding to step (10);
(7) Processing said transaction demand and proceeding to step (9);
(8) Processing said transaction priority and proceeding to step (9);
(9) Obtaining necessary approvals for said transaction and sending appropriate notifications;
(10) Scheduling said transaction for execution and sending appropriate notifications;
(11) Processing said transaction for execution and sending appropriate notifications; and
(12) Completing said transaction and sending appropriate notifications.

3. The infrastructure operations management system of claim 1 wherein said system database incorporates information on IT services, capacity planning, facilities, personnel, infrastructure management, and space planning for said enterprise.

4. The infrastructure operations management system of claim 1 wherein said transaction processing system further comprises confirmation, notification, instruction, and work order processing subsystems.

5. The infrastructure operations management system of claim 1 wherein said transaction processing system further comprises tools available via said user interface to permit creation of tasks, editing of tasks, task cancellation, task status marking, task approval, task scheduling, task completion, and task survey/feedback, and task status viewing.

6. The infrastructure operations management system of claim 1 wherein said transaction processing system further comprises tools available via said user interface to permit creation of summary and statistics reports.

7. The infrastructure operations management system of claim 1 wherein said transaction processing system further comprises tools available via said user interface to permit archiving of configurations and processes for said enterprise.

8. The infrastructure operations management system of claim 1 wherein said transaction processing system further comprises tools available via said user interface that are specific to particular types of users, including end-users, management, technicians, administrators, and support users.

9. The infrastructure operations management system of claim 1 wherein said system database contains data that is organized by enterprise domain.

10. The infrastructure operations management system of claim 1 wherein a business process description and control language is utilized to support flexibility, configuration, and/or modeling of processes within said transaction processing system.

11. An infrastructure operations management method comprising:
(a) integrating user requests among an enterprise over a computer network with a user interface under control of a computer system;
(b) communicating said user requests to a computer system implementing a transaction processing system further comprising request management, problem management, and resource allocation subsystems;
(c) queuing tasks for requests, problems, or resource allocations to external subsystems by said transaction processing system; and
(d) communicating the results of said transaction processing system to an end user, manager, administrator, support personnel, or technician within said enterprise;
wherein
said tasks are processed and controlled via a process and control language definition;
said transaction processing system coordinates said task deployment, status of said task deployment, and results of said task deployment via a system database; and
said transaction processing system permits localized control and integration of said tasks among infrastructure and information technology services within said enterprise.

12. The infrastructure operations management method of claim 11 wherein said transaction processing system further comprises the steps of:
(1) Accepting a transaction submitted by a user and sending appropriate notifications;
(2) Classifying said transaction as a problem, request, and/or change;
(3) If said transaction is a problem, proceeding to step (6);
(4) If said transaction is a request, proceeding to step (7);
(5) If said transaction is a change, proceeding to step (8);
(6) Processing said transaction severity and proceeding to step (10);
(7) Processing said transaction demand and proceeding to step (9);
(8) Processing said transaction priority and proceeding to step (9);
(9) Obtaining necessary approvals for said transaction and sending appropriate notifications;
(10) Scheduling said transaction for execution and sending appropriate notifications;
(11) Processing said transaction for execution and sending appropriate notifications; and
(12) Completing said transaction and sending appropriate notifications.

13. The infrastructure operations management method of claim 11 wherein said system database incorporates information on IT services, capacity planning, facilities, personnel, infrastructure management, and space planning for said enterprise.

14. The infrastructure operations management method of claim 11 wherein said transaction processing system further comprises confirmation, notification, instruction, and work order processing subsystems.

15. The infrastructure operations management method of claim 11 wherein said transaction processing system further comprises tools available via said user interface to permit creation of tasks, editing of tasks, task cancellation, task status marking, task approval, task scheduling, task completion, and task survey/feedback, and task status viewing.

16. The infrastructure operations management method of claim 11 wherein said transaction processing system further comprises tools available via said user interface to permit creation of summary and statistics reports.

17. The infrastructure operations management method of claim 11 wherein said transaction processing system further comprises tools available via said user interface to permit archiving of configurations and processes for said enterprise.

18. The infrastructure operations management method of claim 11 wherein said transaction processing system further comprises tools available via said user interface that are specific to particular types of users, including end-users, management, technicians, administrators, and support users.

19. The infrastructure operations management method of claim 11 wherein said system database contains data that is organized by enterprise domain.

20. The infrastructure operations management method of claim 11 wherein a business process description and control language is utilized to support flexibility, configuration, and/or modeling of processes within said transaction processing system.
